(19) United States
(12) Patent Application Publication
(10) Pub. No.: US 2006/0038895 A1
(43) Pub. Date: Feb. 23, 2006

(54) Image processing device

(75) Inventors: Masayasu Suzuki, Kawasaki-shi (JP); Takeshi Akatsuka, Yokohama-shi (JP); Tatsumi Yanai, Tokyo (JP)

Correspondence Address: MCDERMOTT WILL & EMERY LLP, 600 13TH STREET, N.W., WASHINGTON, DC, 20005-3096, US

(73) Assignee: NISSAN MOTOR, CO., LTD.

(21) Appl. No.: 11/197,295

(22) Filed: Aug. 5, 2005

(30) Foreign Application Priority Data
Aug. 19, 2004 (JP) P2004-239295
Aug. 19, 2004 (JP) P2004-239296

(51) Int. Cl. H04N 5/228; H04N 5/225

(52) U.S. Cl. 348/222.1

(57) ABSTRACT

An image processing device is provided with an input section through which input image data is inputted from an image pickup device that is obtained by picking up an image of a circumference, a storage section storing an address conversion table describing a relation between address information of the input image data and address information of display image data corresponding to a display resolution, an image processing section processing the input image data to cut out image data, corresponding to the display resolution, from the input image data upon referring to the address conversion table, so as to allow address information of the resultant cut out image data to be converted to address information of the display image data, and an output section outputting the display image data to the display. An address space of the address information of the input image data has a size greater in a height direction or a width direction than that of the display image data.

### BACKGROUND OF THE INVENTION

The present invention relates to an image processing device and, more particularly, to an image processing device wherein images around a vehicle circumference are picked up to allow the pickup images to be converted for provision to a driver.

In recent years, attempt has heretofore been made to provide vehicle circumference display devices in driving assist systems that assist drivers for supplementing their visual fields during reverse driving of a vehicle like backing into a garage or parallel parking while pulling over to the kerb, or during running of a vehicle approaching to a blind intersection or a T-shaped road.

Japanese Patent Application Laid-Open Publication No. 2001-163132 discloses a structure wherein cameras pick up images around rearward blind corners of a vehicle and resulting picked-up images are converted to images as viewed from virtual camera positions different from real camera positions. That is, with such an image processing device, converting input images picked up at the real camera positions allows an area, in which output images are provided, to be varied.

### SUMMARY OF THE INVENTION

However, upon studies conducted by the present inventors, such a structure is deemed to suffer from errors in production of cameras, errors in mounting the cameras caused by workers for mounting the same and vibrations occurring during vehicle traveling with the resultant occasions for optical axes of camera lenses to result in displacement from predetermined positions, respectively. The presence of deviation in such optical axes becomes synonymous with the occurrence of deviation in camera image pickup areas and, hence, it is desired for the deviations of the optical axes to be calibrated.

Here, it is conceivable that in order to allow the image processing device to calibrate the deviations of the optical axes of the cameras for display of images to be provided, memories are implemented to incorporate address conversion tables, through which the camera images are converted, with a view to correcting the deviations in the optical axes.

However, in such cases, need arises for the address conversion tables to be prepared for directions, in which the optical axes are deviated, and the degrees of deviations, respectively; that is; there is a need for a huge amount of address conversion tables to be prepared, resulting in a tendency with an increase in a memory capacity of the image processing device.

Further, it is conceivable that for the purpose of suppressing the increase in the memory capacity, the image processing device generates the address conversion tables on a real time basis upon taking the deviations of the optical axes into consideration. This results in an increase in the amount of calculations required for the generation of the address conversion tables, providing a tendency with an increase in operating load of a CPU. Under such conditions, if delays occur in inputting image data delivered from a plurality of cameras or in outputting image data to a monitor, the CPU may conceivably operate in a disrupted status and it is deemed for a probability to occur with an inability of providing a display of images.

In addition, upon other studies conducted by the present inventors, if a plurality of cameras, installed on a vehicle body, pick up images of circumferences around the vehicle to be provided to a driver while switching over the images picked up at respective image pickup positions, a probability occurs with the images being switched over in an interruptive fashion with the resultant occurrence of a tendency for the driver to be unable to instantaneously recognize which location of the vehicle circumference to be displayed.

Here, it is conceivable for the images of the vehicle circumference to be consecutively displayed when switching an image, picked up by a camera installed at one mount position, over to an image, picked up by a camera installed at the other mount position, while implementing pan control in a way to effectuate parallel shift in image pickup directions of the cameras under situations where the cameras are fixed in place. By switching over the image, picked up by the one camera, to the other image picked up by the other camera when the image, picked up upon executing pan control of the one camera, overlaps with the image picked up by the other camera, it becomes possible for the driver to be easily recognize which location of the vehicle circumference to be displayed.

However, the mount positions and the image pickup directions (of the optical axes) of on-vehicle cameras are normally fixed in place and become hard to be physically altered, resulting in a current status with a difficulty in consecutively switching over the images in actual practice.

That is, under situations where for the purpose of employing certain on-vehicle cameras, whose mount positions and image pickup directions are fixedly secured, to consecutively provide a display from the image, picked up by one camera, to the image picked up by the other camera, address conversions are implemented on the images as viewed from a virtual position, at which the cameras are mounted, between the two cameras, a display is provided in the same way as that in which the pan control is executed for the image pickup directions of the cameras and, hence, a need arises for the memory to implement vast amounts of address conversion tables, resulting in a tendency with an increase in the memory capacity.

Further, when generating the address conversion tables on a real time basis in order to suppress such an increase in the memory capacity, all the same, the amount of calculations increases with the resultant tendency of an increase in operating load of the CPU.

Therefore, the present invention has been completed with studies mentioned above and has an object to provide an image processing device that is able to execute image conversion with less memory capacity and less load in operation.

Further, the present invention has an object to provide an image processing device that can consecutively switch over images display without causing an enormous increase in a memory capacity and with simplified operations even when using image pickup devices whose mount positions and image pickup directions are fixedly secured.

To achieve the above objects, one aspect according to the present invention provides an image processing device comprising: an input section through which input image data is inputted from an image pickup device, the input image data being obtained thorough the image pickup device picking up an image of a circumference; a storage section storing an address conversion table describing a relation between address information of the input image data and address information of display image data corresponding to a display resolution, the display resolution being defined with the number of pixels in height and width directions of a display, and an address space of the address information of the input image data having a size greater in a height direction or a width direction than that of the display image data; an image processing section processing the input image data to cut out image data, corresponding to the display resolution, from the input image data upon referring to the address conversion table, for thereby allowing address information of the resultant cut out image data to be converted to address information of the display image data; and an output section outputting the display image data, resulting from conversion of the address information by the image processing section, to the display.

Stated in another way, another aspect according to the present invention provides an image processing device comprising: inputting means for inputting image data from an image pickup device picking up an image of a circumference; storing means for storing an address conversion table describing a relation between address information of the input image data and address information of display image data corresponding to a display resolution, the display resolution being defined with the number of pixels in height and width directions of a display, and an address space of the address information of the input image data having a size greater in a height direction or a width direction than that of the display image data; image processing means for processing the input image data to cut out image data, corresponding to the display resolution, from the input image data upon referring to the address conversion table, for thereby allowing address information of the resultant cut out image data to be converted to address information of the display image data; and output means for outputting the display image data, resulting from conversion of the address information, to the display.

Other and further features, advantages, and benefits of the present invention will become more apparent from the following description taken in conjunction with the following drawings.

### BRIEF DESCRIPTION OF THE DRAWINGS

FIG. 1 is a block diagram showing a structure of a vehicle circumference display system having an image processing device of a first embodiment according to the present invention;

FIG. 2A is a view showing an address conversion object image for the image processing device of the presently filed embodiment;

FIG. 2B is a view showing operations to provide a display of display images at different positions based on the address conversion object image shown in FIG. 2A, in the presently filed embodiment;

FIG. 3A is a view showing image areas, corresponding to a display mode of a monitor, in a vehicle circumference display system having an image processing device of a second embodiment according to the present invention;

FIG. 3B is a view showing an overlay image, which is shifted with respect to the image area shown in FIG. 3A, to be superimposed on such an image area, in the presently filed embodiment;

FIG. 4A is a view showing image areas, corresponding to a display mode of a monitor, in a vehicle circumference display system having an image processing device of a third embodiment according to the present invention;

FIG. 4B is a view showing an overlay image, which is displayed in a given position of a monitor in a superimposed relationship with the image area shown in FIG. 4A, in the presently filed embodiment;

FIG. 4C is a view showing a status under which the image area shown in FIG. 4A is shifted to allow the overlay image, shown in FIG. 4B, to be superimposed on the shifted image area for display, in the presently filed embodiment;

FIG. 5 is a block diagram showing a structure of a vehicle circumference display system having an image processing device of a fourth embodiment according to the present invention;

FIG. 6 is a view for illustrating a basic sequence of operations to restructure address conversion tables to allow images to be displayed in accordance with an image layout in the image processing device of the presently filed embodiment;

FIG. 7 is a flowchart for illustrating a basic sequence of operations to restructure the address conversion tables in the image processing device of the presently filed embodiment;

FIG. 8A is a view showing image pickup areas for a plurality of camera modules in a vehicle circumference display system having an image processing device of a fifth embodiment according to the present invention;

FIG. 8B is a view showing a picked-up image with no deviation in optical axes when picking up images with a plurality of camera modules shown in FIG. 8A, in the presently filed embodiment;

FIG. 8C is a view showing a picked-up image with the occurrence of deviation in optical axes when picking up the images with the plurality of camera modules shown in FIG. 8A, in the presently filed embodiment;

FIG. 9A is a view showing a display of picked-up images in pixels in the absence of deviation in the optical axes when picking up the images with the plurality of camera modules shown in FIG. 8A, in the presently filed embodiment;

FIGS. 9B to 9D are views showing picked-up images in pixels in the presence of deviation in the optical axes when picking up the images with the plurality of camera modules shown in FIG. 8A, in the presently filed embodiment;

FIG. 10 is a flowchart illustrating a basic sequence of operations to calibrate the deviated optical axes of the camera modules in accordance with a feature of an object in the image processing device of the presently filed embodiment;

FIG. 11A is a view showing an address conversion object image in a vehicle circumference display system having an image processing device of a sixth embodiment according to the present invention;

FIG. 11B is a view for illustrating operations to cut out pre-switchover image and a post-switchover image from the address conversion object image shown in FIG. 11A with a view to displaying intermediate images, in the presently filed embodiment;

FIG. 12 is a view showing a status wherein the intermediate images are consecutively displayed between the pre-switchover image and the post-switchover image in the image processing device of the presently filed embodiment;

FIG. 13 is a view for illustrating a comparative example of the image processing device of the presently filed embodiment; and

FIG. 14 is a view showing image conversion executed using address conversion tables of unified address information between input image data resulting from image picking-up, in the presently filed embodiment.

### DETAILED DESCRIPTION OF THE PREFERRED EMBODIMENTS

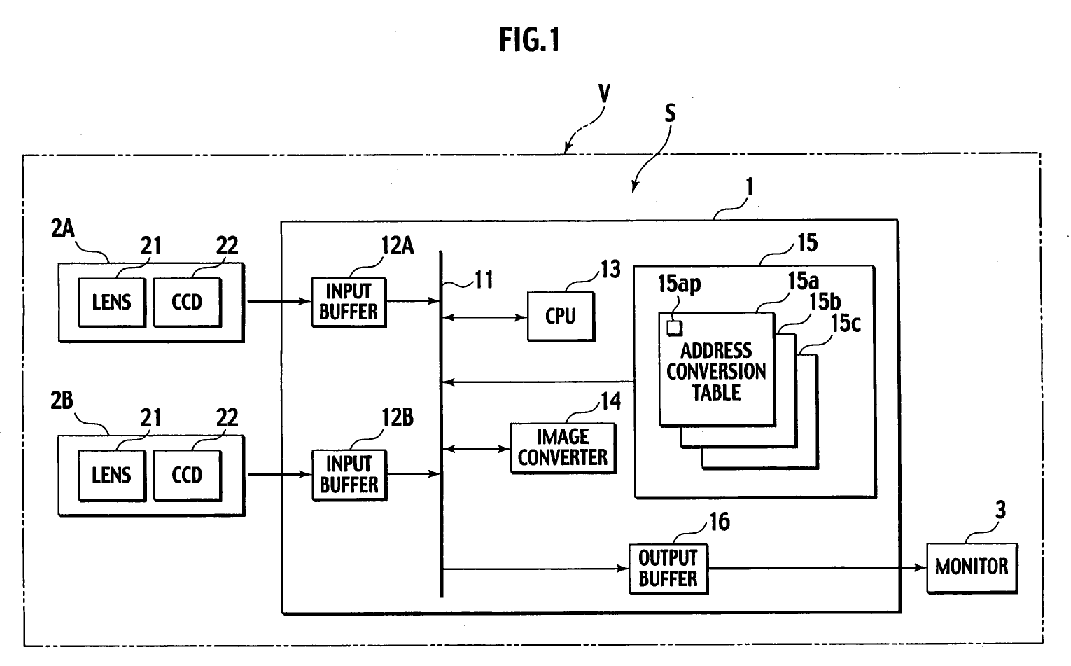

Hereinafter, image processing devices of various embodiments according to the present invention are described in detail with reference to FIGS. 1 to 14.

### First Embodiment

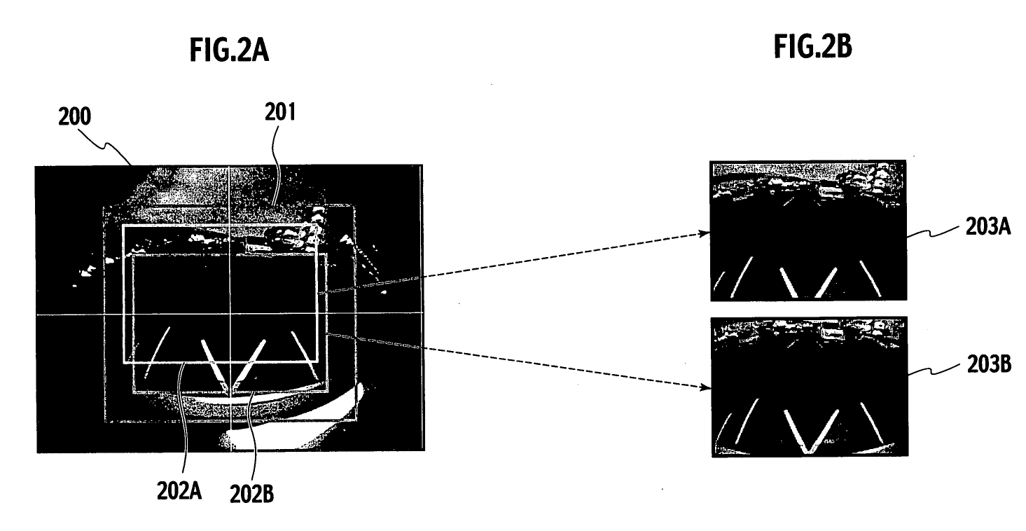

First, an image processing device 1 of a first embodiment according to the present invention is described in detail with reference to FIGS. 1 to 2B.

FIG. 1 is a block diagram showing a structure of a vehicle circumference display system S with the image processing device of the presently filed embodiment; FIG. 2A is a view showing address conversion object images to be used in the image processing device of the presently filed embodiment; and FIG. 2B is a view for illustrating a process by which display images indicative of different positions are displayed based on the address conversion object images shown in FIG. 2A, in the presently filed embodiment.

[Structure of Vehicle Circumference Display System]

As shown in FIG. 1, the vehicle circumference display system S, including the image processing device 1, is comprised of a plurality of camera modules 2A, 2B (which when generally named, may also be merely referred to as “camera modules” in brief) and a monitor 3, which are installed on a vehicle V and to which the image processing device 1 is connected. Although the presently filed embodiment will be described below with reference to a case where two camera modules 2A, 2B are provided, an arbitrary number of camera modules may be employed in principle in such a manner that one or more camera modules can surely pickup images of a surrounding area of a moving object such as a vehicle, on which one or more camera modules are installed, with a wider range than a image to be displayed on the monitor 3.

The cameral modules 2A and 2B are installed on the vehicle at different positions in different image pickup directions that are fixed in place. The camera module 2A is located in a rear of a vehicle body at a right side thereof to provide an image pickup direction covering a blind spot at a right side area of a driver and the camera module 2B is located in the rear of the vehicle body at a left side thereof to provide another image pickup direction covering a blind spot at a left side area of the driver.

Further, the cameral modules 2 are comprised of image pickup lenses 21 and CCDs (Charge-Coupled Devices) 22, respectively. Incidentally, the camera modules 2 include NTSC (National Television System Committee) cameras from which image data are outputted to the image processing device 1 in accordance with NTSC systems, respectively.

The image pickup device 1 takes the form of a structure that includes an internal bus 11 to which other component elements, that is, input buffers 12A, 12B (which when generally called, will be merely referred to as “input buffers 12”), a CPU (Central Processing Unit) 13, an image converter (image processing section) 14, a table storage unit (table memory) 15 and an output buffer 16 are connected.

The input buffers 12 are provided in compliance with the number of cameral modules 2, respectively. The input buffers 12A is connected to the camera module 2A and the input buffers 12B is connected to the camera module 2B. The input buffers 12 store input image data in the NTSC system once to allow input image date to be read out at image conversion timings of the image converter 14.

The table storage unit 15 stores address conversion tables 15a, 15b, 15c, . . . for respective image layouts to be provided to the driver. That is, under a situation where a right area image and a left area image are displayed on the monitor 3 on a single screen, the address conversion tables based on such image layouts are used and when displaying, in addition to the right area image and the left area image, a lower area image on the monitor 3 on the single screen, the address conversion tables based on such image layouts are used.

Here, the monitor 3 has a resolution of a display or a resolution of a monitor (so-called display resolution or monitor resolution: for the sake of convenience, an abbreviation such as a terminology “resolution” may be briefly appeared in the description) that is defined by the number of pixels in a height direction (vertical direction) and the number of pixels in a width direction (lateral direction) of a display screen of the monitor 3 such as QVGA (in 320 pixels wide by 240 pixels tall: 320 pixels in a width direction×240 pixels in a height direction), VGA (640 pixels in a width direction×480 pixels in a height direction) and the like. Each of the address conversion tables 15a, 15b, 15c, . . . to be stored in the table storage unit 15 includes a table describing both a memory address (address information) of input image data of the input buffers 12 from the cameral modules 2 and a memory address (address information) of the output buffer 16 for display image data that is displayed on the monitor 3 and corresponds to the resolution of the monitor 3. Also, the memory address of input image data has an address space with a size greater than that of display image data in a height direction or a width direction (particularly, with a greater number of pixels in the height direction or the width direction). That is, the address conversion table describes a correspondence relation between a coordinates of the memory address of the input buffers 12, that is, the inputted pickup image, and a coordinates of the memory address of the output buffer 16, that is, the display image to be provided on the monitor 3. Such address conversion tables are preliminarily prepared based on specifications of the camera modules 2, that is, the camera modules 2A, 2B, mounting positions at and directions (orientations of optical axes) in which images are picked up, and the like. Incidentally, in the presently filed embodiment, the memory address (address information) of input image data of the input buffers 12 from the cameral modules 2 contains both a memory address (address information) of input image data of the input buffer 12A from the cameral module 2A and a memory address (address information) of input image data of the input buffer 12B from the cameral module 2B. Namely, the address conversion tables 15a, 15b, 15c, . . . make it possible to achieve conversion not only based on the address space in a size corresponding to the image to be provided on the monitor 3 but also based on the address space in a size greater than that of such an address space, corresponding to the image to be provided on the monitor 3, in a height direction or a width direction. Of course, the conversion may be achieved based on an address space greater than the address space, both in the height direction and the width direction, with the size corresponding to the image to be displayed on the monitor 3.

The image converter 14 reads out either one of the address conversion tables 15a, 15b, 15c, . . . from the table storage unit 15 to allow input image data, stored in the input buffers 12, to be stored in the output buffer 16 by referring to such an address conversion table. Since the address conversion table describes the memory addresses of the output buffer 16 in accordance with the image layouts, the display image data, to be stored in the output buffer 16 by the image converter 14, is converted to image data in an image layout represented by such an address conversion table.

When this takes place, more particularly, the image converter 14 serves to determine an image area corresponding to a display mode (with the resolution of the monitor) of the monitor 3 to be used in actual display after conversion upon referring to the associated address conversion table while achieving address conversion, forming rewriting operation, which rewrites the respective pixels of image data, of the input buffers 12, contained in such an image area, into respective pixels of image data of the output buffer 16. Although a need arises for cutting out the image area targeted to be address conversion in actual practice for the purpose of providing an image display in accordance with the display mode and the image layout of the monitor 3, the cut-out of the image area is executed by designating a leading pointer (address information) described in the address conversion table upon which the operation is executed to cut out the image area from the address at such a leading pointer. Incidentally, the image converter 14 may include an LSI (Large Scale Integration), an FPGA (Field Programmable Gate Array) and a DSP (Digital Signal Processor) or may be substituted in the form of functions of the CPU 13 per se. Moreover, FIG. 1 shows only the leading pointer 15ap of the address conversion table 15a and, likewise, the other address conversion tables have leading pointers, respectively, with leading pointers being also stored in memories, not shown, of the image converter 1 in correspondence with the respective address conversion tables.

With such a structure, the image converter 14 executes operation, in a manner as described below in detail, to calibrate deviation, resulting from physical deviation occurred in the optical axes (orientations of the optical axes) with respect to initial states at which the camera modules 2 are mounted, of the image to be displayed on the monitor 3.

The output buffer 16 stores image data, subjected to address conversion by the image converter 14, that is, image data for display on the monitor 3 to output such image data to the monitor 3 under controls executed by the CPU 13.

The CPU 13 recognizes a command on an image layout and a command on image switchover, determined upon operations of an operation input unit, not shown, manipulated by a driver, and determines an address conversion table to be used in image converting operations to be executed in the image converter 14. Further, the CPU13 controls image conversion timings for the image converter 14 in respect of image data, delivered from the input buffers 12, and timings at which image data are outputted from the output buffer 16 to the monitor 3, thereby switching over the images to be displayed on the monitor 3.

[Address Converting Operations]

Next, the address converting operations, to be executed by the image processing device 1 with the structure set forth above, are described below in detail.

With the monitor 3 represented in a display mode (the resolution of the monitor 3) with a QVGA (320 pixels in a width direction×240 pixels in a height direction) and a CCD 22 represented with the number of pixels in a width direction and a height direction, that is, image data stored in the input buffers 12 represented with the number of pixels in a width direction and a height direction, with VGA (640 pixels in a width direction×480 pixels in a height direction), suppose a required image is cut out for address converting operation based on such inputted image data of VGA.

Therefore, the address conversion table is required to have an address conversion object area that corresponds to an image area with a size greater than an aspect size the display mode of the monitor 3 (the resolution of the monitor 3) in a height direction or a width direction or in both directions.

More particularly, an address space, corresponding to image data targeted for the address converting operations to be executed, is set to be 400 pixels wide by 300 pixels tall (400 pixels in a width direction×300 pixels in a height direction). Then, as shown in FIG. 2, among a camera image (input image data) 200 with 640 pixels wide by 480 pixels tall (640 pixels in a width direction×480 pixels in a height direction) picked up in the image pickup areas of the camera, an image 201 (targeted as address conversion object image data) in 400 pixels wide by 300 pixels tall is targeted as an address conversion object.

That is, the address conversion table stores a correspondence relation of address information in 400 pixels wide by 300 pixels tall to be targeted as the address conversion object to address information 320 in 320 pixels wide by 240 pixels tall for the monitor 3.

Further, the address conversion tables are prepared for the camera modules 2, respectively, for respective cases with their optical axes fixed in preset values. Incidentally, if the address conversion object image 201 becomes closer to a contoured area of the camera image 200, distortion occurs in an image at a peripheral edge of the contour and, hence, the address conversion tables are set to have address conversion object areas each in a range with a resolution greater than that of the monitor 3 but in a range not to cause distortion in the image.

Furthermore, leading pointers are set on the address conversion tables for the camera modules 2, respectively. That is, the address conversion table 15a, typically as shown in FIG. 1, has a leading pointer 15ap set on address information at a leftward and upper end of the address conversion information area, thereby permitting an image to be cut out in 320 pixels wide by 240 pixels tall for the monitor 3 from the leading pointer 15ap. Such a structure similarly applies to other address conversion tables.

With such an operation, when reading out camera images from the input buffers 12, the image converter 14 reads out data from the input buffers 12 that serves as a source from which data is read out, that is, leading pointers and address conversion tables corresponding to the camera modules 2, respectively. Then, the image converter 14 cuts out an image area 202A for display on the monitor 3 as shown in FIG. 2A; that is, a display image 203A, shown in FIG. 2B, is replaced in the output buffer 16, thereby enabling such an image 203A to be displayed on the monitor 3.

However, here, on the condition that the camera image 200 is deviated upward in FIG. 2A due to physical displacements of the optical axes of the camera modules 2, a difficulty is encountered in cutting out the image area 202A to be originally cut out in accordance with the leading pointer for corresponding one of the camera modules 2, resulting in an issue with an image area (shown as an image area 202B in FIG. 2A) being cut out under a position deviated from the image area 202A. That is, as shown in FIG. 2B, this results in an occasion where no display image 203A to be originally displayed on the monitor 3 is displayed but the display area 203B is caused to be erroneously displayed.

On the contrary, the image processing device 1 of the presently filed embodiment takes the form of a structure wherein a correction is performed so as to cause the leading pointer to be displaced in a manner which will be described later in detail whereby the image area 202A is cut out for display of the display image 203A without causing alteration in the existing address conversion table. That is, the camera module 2 picks up the camera image 200 in a size corresponding to the camera image pickup area for storage in the input buffers 12 and, subsequently, the deviated display image 203B can be switched over to the correct display image 203A depending on the physical deviation of the camera module 2.

Further, the leading pointers of the address conversion tables, which are set in a way to calibrate the deviations in the optical axes, are set to be commonly used regardless of the image layouts to be displayed on the monitor 3, thereby eliminating a need for calibrating the deviations of the camera modules 2 for the image layouts to be provided to the driver, respectively.

At the same time, the leading pointers of the address conversion tables, set in a way to calibrate the deviations of the optical axes, are stored in a non-volatile memory, not shown, of the image processing device 1. This enables stored content to be sustained even when the image processing device 1 is powered off, eliminating a need for the executions of calibrations on deviations of the optical axes of the camera modules 2, that is, calibrations of the calibrated image pickup areas whenever the camera modules 2 are used.

[Image Calibrating Operations Based on Vehicle Information]

Next, description is made of image calibrating operations to be executed for calibrations of deviations in the optical axes of the camera modules 2 based on vehicle information indicative of circumferences of an own vehicle.

The image calibrating operations contemplate to vary the image areas, cut out from the camera images, based on vehicle information. When this takes place, the image converter 14 varies the leading pointer of the address conversion table for thereby varying the image area to be cut out upon referring to the address conversion table.

Here, the address conversion tables, stored in the table storage unit 15, are prepared based on parameters such as directions (orientations of the optical axes) in and positions at which the camera modules 2 are mounted, respectively, under a status with no load on the own vehicle in the absence of occupants and packages. Accordingly, if a vehicle height changes due to some factors such as situations where many occupants get in or many packages are loaded in the own vehicle, the optical axes of the camera modules 2 are deviated, resulting in deviations in respective image pickup areas. That is, when the address conversion object area is cut out from the leading pointer stored with the address conversion table that is initially set, an issue arises with the occurrence of deviation in the image to be provided on the monitor 3.

To address such an issue, with the presently filed embodiment, sensors for detecting behaviors of the own vehicle, that is, vehicle height sensors (not shown), are mounted on the vehicle in the vicinity of mount positions of the camera modules 2, respectively, and the CPU 13 reads out sensor signals delivered from the vehicle height sensors to detect a current vehicle height of the own vehicle.

Then, the CPU 13 obtains a difference between the current vehicle height, read out from the vehicle height sensors, and the vehicle height, appearing when the vehicle bears no load, that is, during operation in which the address conversion tables are calculated, thereby calculating a value indicative of how many number of pixels are involved in deviation typically in a height direction of the image pickup area of the camera module 2.

Subsequently, the image converter 14 shifts the leading pointer by a value of deviation in pixels of the camera image pickup area, calculated by the CPU 13, to shift the address conversion object area to be cut out upon referring to the address conversion table, for thereby executing a calibration of deviation in the camera image pickup area. Incidentally, the calculation of the vehicle height by the CPU 13 and the shift of the leading pointer of the address conversion table by the image converter 14 may be carried out on a real time basis or may be stored in the table storage unit 15 together with the address conversion tables and the leading pointers.

By so doing, even in cases where short-term deviations occurs in the image pickup areas of the camera modules 2 due to behaviors of the own vehicle like cases where positions and weights of occupants getting on the own vehicle are different, the image processing device 1 is capable of correcting the deviations in the image pickup areas for the camera modules 2, respectively, based on signals carrying vehicle information causing adverse affects on the image pickup areas, enabling a driver to be provided with an image on a proper image pickup area.

As set forth above, with the image processing device 1 of the presently filed embodiment, the address conversion tables are prepared each with the address space greater than the address space corresponding to the resolution of the monitor 3 and the positions of the leading pointers, to be cut out from the camera images, based on such address conversion tables are set in a way to calibrate the physical deviations of the optical axes of the camera modules 2. This results in a capability of eliminating a need for preparing a large volume of address conversion tables for displaying images upon calibrations of the image pickup areas of the camera modules 2, while making it possible for the image pickup areas to be calibrated in a simplified operation.

Incidentally, although the above structure has been mentioned with reference to cases where among the camera images stored in the input buffers 12, an image corresponding to the resolution of the monitor designated by the leading pointer of the address conversion table is cut out for calibration, operations may be executed to achieve writing address conversion to allow the camera images to be stored in the output buffer 16 by sequentially referring to the address conversion tables.

In addition, it is of course to be appreciated that such a structure is able to be applied not only to a case in which use is made of address conversion tables for operations to cut out camera images but also to a structure that employs address conversion tables addressing distortion converting operation, which takes into consideration scaling operation, by which image providing areas are operated, and distortions in lenses, and viewing point converting operation that permits the conversion into images in terms of virtual viewing points.

Now, a comparative example for the presently filed embodiment is simulated in a structure wherein an address conversion table has an address space in 320 pixels wide by 240 pixels tall that make up a monitor resolution and address conversion tables are used each of which stores a correspondence with of the output buffer 16, that is, an arbitrary coordinates of the monitor 3, to an arbitrary input buffers 12, that is, coordinates information for reading out an arbitrary coordinates of the camera image for updating. The address conversion tables are prepared based on information such as specifications, mount positions and directions (of the optical axes) of the camera modules 2.

In cases where the image converter 14 generates images to be provided to a driver by using address conversion tables with such a structure, if the camera modules 2 are physically dislocated from respective original positions, then, an issue arises with the occurrence of deviations in the image pickup positions of the camera modules 2 with the resultant deviations in image providing ranges after address converting operations have been completed.

To avoid such an issue, if address conversion tables for altered positions and directions (of the optical axes) of the cameras are prepared for layouts, respectively, for calibrations of the camera image pickup areas, a need arises for a huge number of address conversion tables to be prepared, resulting in an enormous increase in table volume. Also, in cases where upon consideration of the physical deviations of the camera modules 2, the address conversion tables are prepared on a real time basis, another issue arises with the occurrence of an increase in the amount of calculations with the resultant increase in processing load.

On the contrary, the image processing device 1 of the presently filed embodiment includes address conversion tables whose areas are expanded to be greater than the relevant areas, corresponding to a resolution of a monitor, in a height direction or a width direction, or in both directions, upon which among camera images, an image corresponding to the resolution of the monitor is cut out by taking into consideration physical deviations of the camera modules 2 whereby mere operations of the image converter 14 enables the physical deviations of the camera modules 2 to be absorbed.

Further, with the image processing device 1, by storing leading pointers for address conversion object areas for the camera modules 2, respectively, no need arises for calibrating the respective camera image pickup areas for the layouts to be provided to the driver. Moreover, using a non-volatile memory as a memory for storing the leading pointers of the address conversion tables enables stored content to be sustained even when the image processing device 1 is powered off, eliminating a need for calibrating the camera image pickup areas for each startup.

### Second Embodiment

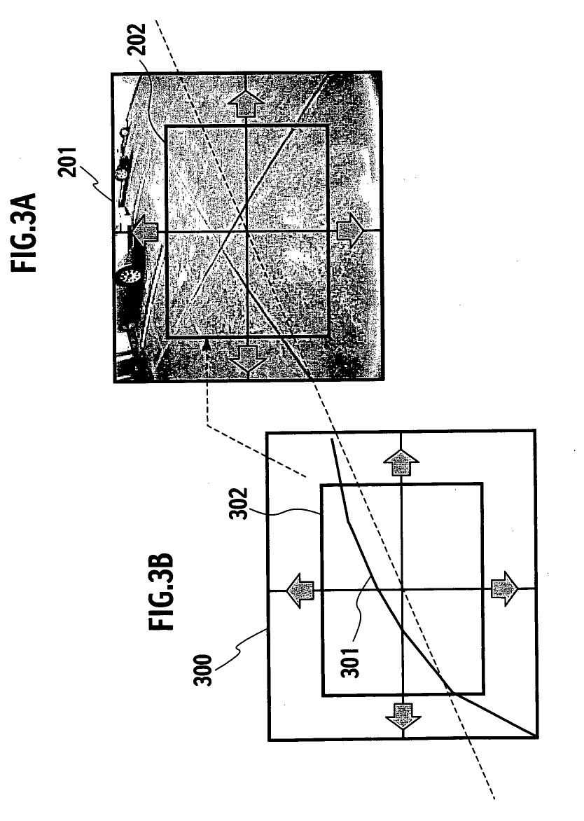

Next, an image processing device of a second embodiment according to the present invention is described below in detail mainly with reference to FIGS. 3A and 3B.

The image processing device of the presently filed embodiment mainly differs from that of the first embodiment in that a display position is calibrated when information (overlay data) is displayed in a superimposed relation with a camera image picked up by a camera module to assist a vehicle driving. Thus, the same component parts as those of the first embodiment bear like reference numerals to suitably omit description or to provide simplified description with a focus on such a differing point.

FIG. 3A is a view showing an image area corresponding to a display mode of a monitor in a vehicle circumference display system with the image processing device of the presently filed embodiment and FIG. 3B is a view showing an overlay image 301 shifted with respect to the image area, shown in FIG. 3A, to be superimposed with such an image area.

Examples of overlay data for preparing the overlay image in the presently filed embodiment may include data representing a locus guideline indicative of a backward locus to be superimposed on an image in a backward area of the own vehicle when the own vehicle moves backward into a given parking line frame to make a stop. Data indicative of such a locus guideline is prepared by an overlay data generator of a vehicle driving assist device, which is not shown, based on steering angles of an own vehicle. Data indicative of such a locus guideline is superimposed on image data, converted with the image converter 14 shown in FIG. 1, by an image generator of a vehicle driving assist device and stored in the output buffer 16.

Here, a superimposing position for the locus guideline is set based on parameters such as the mount positions and directions (of the optical axes) of the camera modules 2 under a situation where the own vehicle bears no load. Accordingly, in cases where camera image pickup areas are deviated due to some factors such as a cause in which the own vehicle bears a weight, deviation occurs in a positional relationship between an image, subjected to conversion by the image converter 14, and a vehicle traveling locus guideline. This results in situation where the vehicle cannot correctly move backward in accordance with the locus guideline, resulting in deterioration in reliability of the locus guideline.

To address such an issue, with the presently filed embodiment, the vehicle driving assist device, which is not shown, generates a locus guideline using the camera image greater than an image, corresponding to a monitor resolution such as QVGA of the monitor 3, which is picked up by the camera module 2.

That is, the operation is executed to prepare an image 300, including the locus guideline, based on overlay data in a way to have an area greater than the image area 202 corresponding to the monitor resolution, as shown in FIG. 3B, using the address conversion object image 201 shown in FIG. 3A. The image 300, including such a locus guideline, has an image area greater than the image, corresponding to the monitor resolution, like the address conversion object image 201 and the address conversion tables, in a height direction or width direction or in both directions.

Then, the image 300, including the locus guideline, is stored in a buffer as data greater than the image area 202 in the monitor resolution and the image generator cuts out the overlay data superimposing image 302 including a locus guideline 301 to be superimposed on the image area 202 in the monitor resolution. The overlay data superimposing image 302 is an image in the monitor resolution which lies in the same image area as the image area 202 in the monitor resolution.

Here, the overlay data superimposing image 302 is cut out with the same leading pointer as that used for cutting out the image area 202 in the monitor resolution.

That is, a leading pointer of an address conversion table, which takes deviation in the image pickup area of the cameral module 2 into consideration, is used as a leading pointer for the image area 202 in the monitor resolution to be cut out and, in addition, the leading pointer of the address conversion table for cutting out the overlay data superimposing image 302 is aligned with the leading pointer which takes into consideration the deviation of the image pickup area of the camera module 2.

As set forth above, the image processing device of the presently filed embodiment employs an image, with a greater area than the image in the monitor resolution, as the image 300 including overlay data for cutting out the overlay data superimpose image 300 using the same leading pointer as that for cutting out image area 202 in the monitor resolution, providing a driver with the overlay data superimposing image 302 and image area 202 in the monitor resolution.

Accordingly, such a structure enables the overlay data superimposing image 302 to be provided in a calibrated position in contrast to the deviation of the image pickup area of the camera module 2, enabling the overlay image 301 to be provided in a correct position.

Further, even if a structure is adopted for detecting the deviation of image area 202 in the monitor resolution on the real time basis, shifting the overlay data superimposing image 302 in conjunction with the amount of shift of the image area 202 in the monitor resolution enables overlay data 301 to be provided in a further correct position.

Incidentally, with the structure of the presently filed embodiment, the address conversion object image 201 and the image 300, including overlay data, do not necessarily coincide with each other and overlay data may be displaced by an identical value provided that a displacement value with respect to a default value of the leading pointer of the address conversion table is turned out.

### Third Embodiment

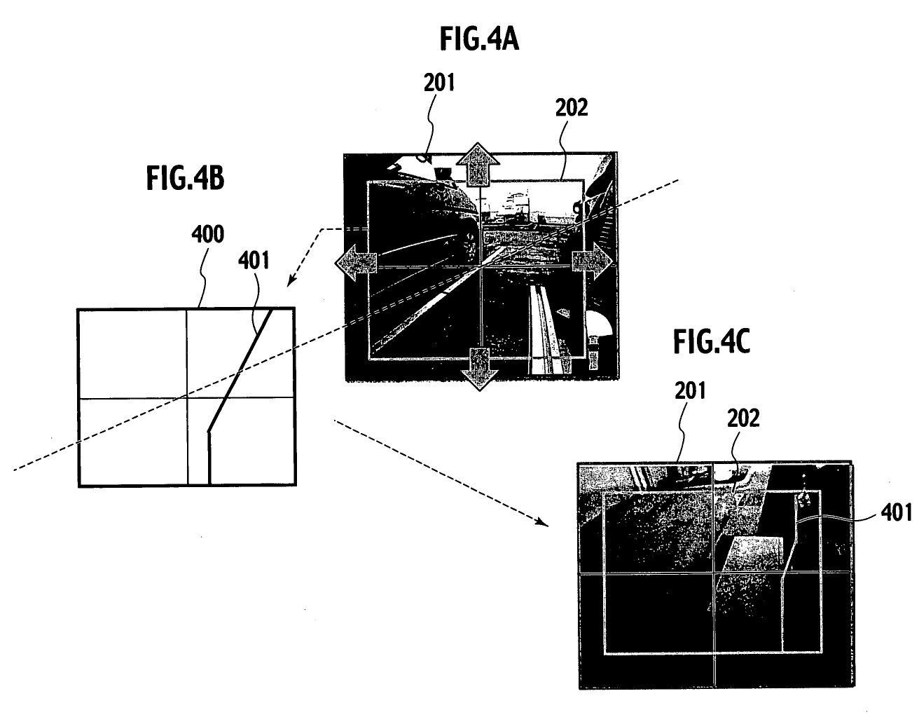

Next, an image processing device of a third embodiment according to the present invention is described below in detail mainly with reference to FIGS. 4A to 4C.

The image processing device of the presently filed embodiment mainly differs from that of the first embodiment in structure wherein under circumstances where a part of an own vehicle is involved in image pickup areas of the camera modules 2, the image pickup areas of the camera modules 2 are calibrated based on overlay data indicative of an absolute reference position of an asymmetric object such as a vehicle body or a bumper of the own vehicle. Thus, the same component parts as those of the first embodiment bear like reference numerals to suitably omit description or to provide simplified description with a focus on such a differing point.

FIG. 4A is a view showing an image area corresponding to a display mode of a monitor in a vehicle circumference display system with the image processing device of the presently filed embodiment; FIG. 4B is a view showing an overlay image to be superimposed on the image area, shown in FIG. 4A, for display on the monitor at a given position thereof; and FIG. 4C is a view showing a status in which the image area, shown in FIG. 4A, is shifted and superimposed on the image area to which the overlay image, shown in FIG. 4B, is shifted.

With the structure of the presently filed embodiment, the camera module 2 is mounted in a position where an image of a vehicle body of the own vehicle is picked up in a right end portion of the address conversion object image 201 shown in FIG. 4A. Here, in cases where the own vehicle, that is, asymmetric object such as a vehicle body and a bumper, are involved in a camera image pickup area, it is known from the specifications, the mount positions and the directions (of the optical axes) of the known camera modules 2 which area of the camera image 200 allows the asymmetric object, such as the vehicle body, to be present.

Accordingly, an overlay image 400 (shown in FIG. 4B), showing an outline (overlay data image 401) of the vehicle body appearing at a right end of the image shown in FIG. 4A, is preliminarily prepared. The overlay image 400 has the same size as that of the image area 202, of the address conversion object image 201, which corresponds to the monitor resolution such as QVGA, and is provided with a leading pointer for the address conversion object image 201 to be cut out based on the parameter, such as the mount positions of the camera modules 2, and the reference position of the vehicle body.

When correcting the position of image area 202 in the monitor resolution, the image processing device of the presently filed embodiment, equipped with the overlay image 400, acquires the leading pointer of the overlay image 400 when the vehicle body inside the address conversion object image 201 and the overlay data image 401 ought to be associated with the vehicle body matches under a condition where the overlay image 400 is superimposed on the address conversion object image 201.

Such a leading pointer is set to the leading pointer of the image area 202 in the monitor resolution, thereby shifting the image area 202 in the monitor resolution based on the overlay data image 401. When this takes place, the camera image pickup area is calibrated by causing the leading pointer of the address conversion table to be shifted from right to left or up and down by a unit pixel with respect to the image in which the address conversion object image 201 and the overlay image 400 are superimposed.

More particularly, the image area 202 in the monitor resolution is aligned as the basis for the overlay data image 401. When this takes place, the overlay image 400 and the image area 202 in the monitor resolution may be aligned with each other depending on manual operations of the driver or may be automatically aligned by the image processing device.

When the alignment is manually made by the driver, the image converter 14, shown in FIG. 1, detects a manual signal from an operation system (not shown) to vary the leading pointer of the address conversion table from right to left or up and down by a unit pixel for the purpose of achieving positional alteration of the image area 202 in the monitor resolution.

On the contrary, when the alignment is automatically made by the image processing device, the image converter 14 allows an image recognizer (not shown) to recognize an outline coordinates of an asymmetric object involved in the address conversion object image 201, upon which the leading pointer of the address conversion table is deviated from left to right or up and down by a unit pixel in a way to align such an outline coordinates and the overlay data 401. Also, the image recognizer stores color information of the asymmetric object, such as the vehicle body, which is preliminarily set and detects an image portion in alignment with such color information as the outline coordinates of the asymmetric object.

Upon executing such routine, the vehicle body within the image area 202 in the monitor resolution and the overlay data image 401 are aligned, enabling the calibrations of the image areas of the camera modules 2 as shown in FIG. 4C.

As set forth above, with the image processing device of the presently filed embodiment, by shifting the image area 202 in the monitor resolution so as to match the overlay data image 401, involved in the image pickup areas of the camera modules 2 located on the vehicle body and the bumper and showing the object represented in a given position of the display screen of the monitor 3, and the object within the address conversion object image 201, it becomes possible to obtain the leading pointer of the address conversion table with calibrated deviations in the image pickup areas of the camera modules 2.

Consequently, the deviations of the camera modules 2 can be further reliably calibrated, enabling the image area 202 in the monitor resolution, involved in the correct image pickup area, to be provided.

### Fourth Embodiment

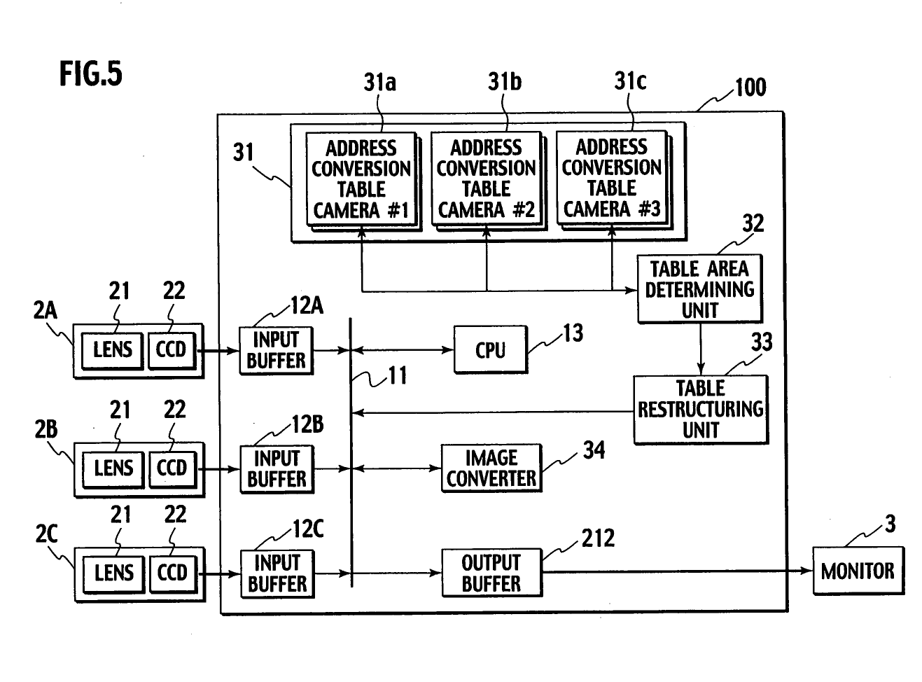

Next, an image processing device of a fourth embodiment according to the present invention is described below in detail mainly with reference to FIGS. 5 to 7.

The image processing device of the presently filed embodiment mainly differs from that of the first embodiment in structure that includes a table storage unit, replaced with the table storage unit 15, and an address converter, replaced with the image converter 14, in the first embodiment and further includes a table area determination section and a table restructuring section. Thus, the same component parts as those of the first embodiment bear like reference numerals to suitably omit description or to provide simplified description with a focus on such a differing point. Incidentally, such address converter, table area determination section and table restructuring section serves as an image processing section.

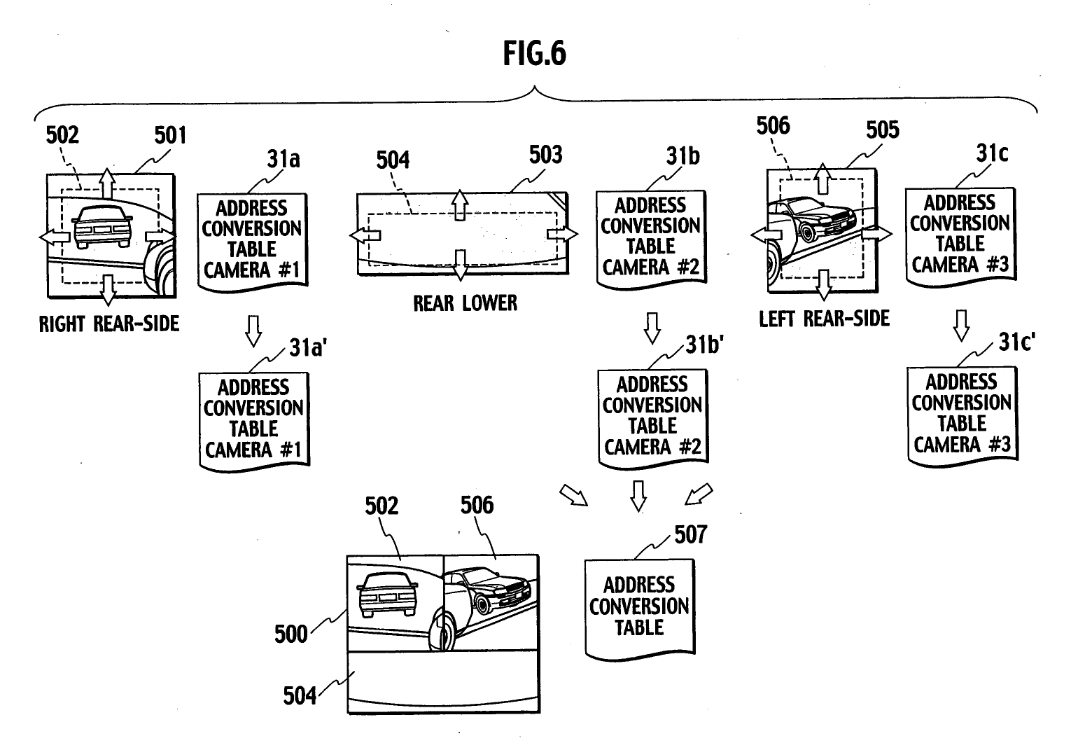

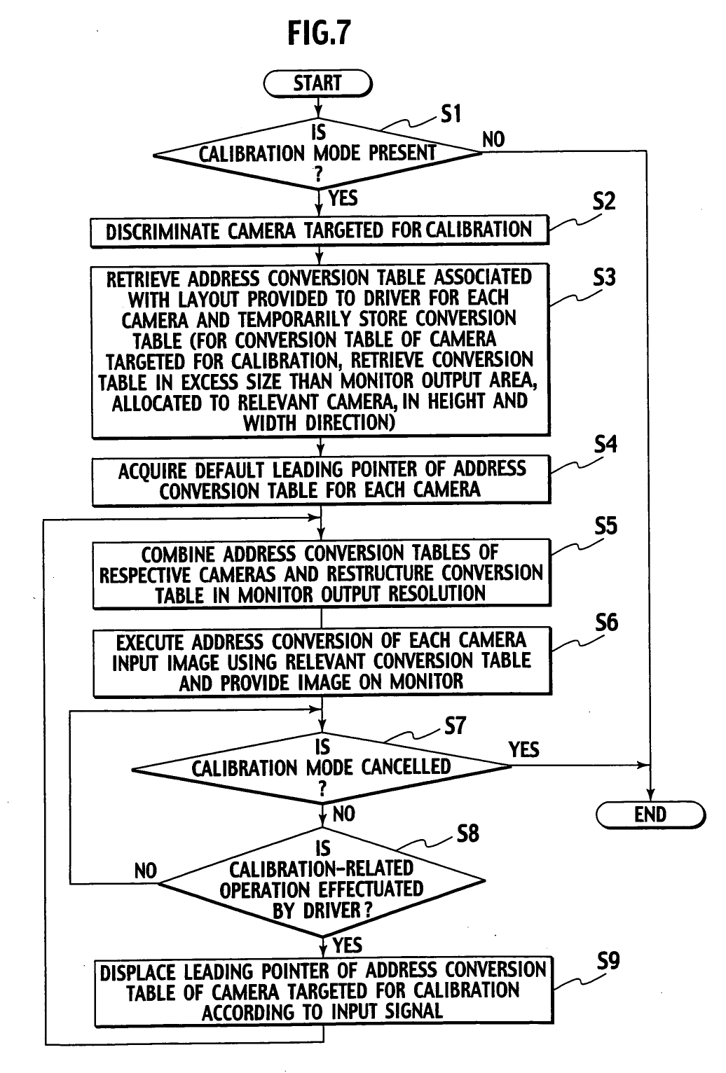

FIG. 5 is a block diagram showing a structure of a vehicle circumference display system with the image processing device 100 of the presently filed embodiment; FIG. 6 is a view for illustrating a basic sequence of operations to display an image in accordance with an image layout upon restructuring an address conversion table in the image processing device of the presently filed embodiment; and FIG. 7 is a flowchart showing a basic operations to restructure the address conversion table in the image processing device of the presently filed embodiment.

As shown in FIG. 5, with the image processing device 100, the table storage unit (table memory) 31 stores a single sheet of address conversion table for each image layout to be displayed on the monitor 3 and each of the cameral modules 2, that is, each of camera modules 2A, 2B, 2C. Stated another way, the address conversion table has an address space associated with an image greater than an image in the monitor resolution such as QVGA forming an image to be displayed on the monitor 3 in the image layout thereof.

A table area determination section 32 determines an address conversion table to be actually used in performing address conversion on the premise of the monitor resolution, such as QVGA, among the address conversion tables set for the image layouts to be provided to a user and the camera modules 2. That is, first, the table area determination section 32 reads out the address conversion table relevant to both the image layouts, to be provided over the monitor 3, and the camera modules 2 by which images involved in the image layouts are picked up.

More particularly, under circumstances where an image layout is configured to allow an image, picked up by the camera modules 2A, to be displayed on the monitor 3 in a right half area thereof and an image, picked up by the camera module 2B, to be displayed on the monitor 3 in a left half area thereof, the table area determination section 32 reads out an address conversion table associated with a half area of the display area in the monitor resolution for use in address conversion to cause the camera image, picked up by the camera module 2A and stored in an input buffers 12A, to be displayed in the right half area of the monitor 3 and reads out an address conversion table associated with another half area of the display area in the monitor resolution for use in address conversion to cause the camera image, picked up by the camera module 2B and stored in an input buffers 12B, to be displayed in the left half area of the monitor 3. Here, although there is a need for the image areas, retrieved from the images picked up by the respective camera modules 2, to be allocated in accordance with the image layout, the respective address conversion tables, to be read out in accordance with the image layouts, have address spaces available to convert the image, whose resolution is greater than the monitor resolution allocated in accordance with the image layout, that is, the image in which at least one of the number of pixels in a width direction and the number of pixels in a height direction of each image to be displayed on the monitor 3 depending on the image layout is large.

The table restructuring section 33 performs restructuring to combine the address conversion tables, retrieved from the table area determination section 32, and prepare the address conversion table equipped with the address space corresponding to the monitor resolution.

In particular, by combining the address conversion table, having the half area of the display area corresponding to the monitor resolution for a display on the monitor 3 in the right half thereof, and the address conversion table, having the other half area of the display area corresponding to the monitor resolution for a display on the monitor 3 in the left halt thereof, the operation is executed to restructure the address conversion table corresponding to one screen (display area corresponding to the monitor resolution) of the monitor 3. Stated another way, the table restructuring section 33 retrieves the address conversion table corresponding to the monitor resolution with the image area allocated depending on the image layout using the address conversion table retrieved by the table area determination section 32. The table restructuring section 33 delivers the restructured address conversion table through the internal bus 11 to an address converter 34.

The address converter 34 performs the substituting operation to substitute camera image data, stored in the input buffers 12, in the output buffer 16 for storage by referring to the restructured address conversion table delivered from the table restructuring section 33.

Under circumstances where the image processing device 100 provides an image layout to allow the images, picked up by the camera modules 2A, 2B, 2C, to be located on the monitor 3 for displaying a composite image 500 on the monitor 3 in combination with a camera image 501 for a right rear-side of an own-vehicle to be picked up by the camera module 2A, a camera image 503 for a rear underside of the own vehicle picked up by the camera module 2B, and a left rear-side of the own vehicle, picked up by the camera module 2C, which are juxtaposed as shown in FIG. 6.

When this takes place, with the image layout being determined for displaying the right rear-side, the left rear-side and the rear underside of the own vehicle, the table area determination section 32 reads out address conversion tables 31a, 31b, 31c, corresponding to such an image layout and associated with the camera modules 2 that take image pickup directions oriented for the right rear-side, the left rear-side and the rear underside of the own vehicle. At this moment, the address conversion tables 31a, 31b, 31c have address spaces each available to convert an image in a size greater than the image in the monitor resolution, that is, the composite image 500 composed of three images.

Next, the table restructuring section 33 determines image areas 502, 504, 506 for the camera images 501, 503, 505 picked up by the respective camera modules 2, necessary for preparing the composite image 500 based on the determined image layout. This determination is executed by deviating the leading pointers of the respective address conversion tables, thereby preparing address conversion tables 31a′, 31b′, 31c′ with the address spaces for the determined image areas 502, 504, 506. That is, the table restructuring section 33 uses the address conversion tables 31a, 31b, 31c, available to convert the images to be greater than the monitor resolution, as the address conversion tables 31a′, 31b′, 31c′ for the monitor resolution to be allocated depending on the image layout with a view to cutting out the image areas 502, 504, 506 in the monitor resolution as a whole. This allows the determination of the areas for the address conversion tables for use in preparing the composite image 500.

Then, the table restructuring section 33 restructures the address conversion tables for the composite image 500 upon combining the address conversion tables 31a′, 31b′, 31c′, allocated depending on the image layouts, in accordance with the image layouts. This allows the preparation of an address conversion table 507 to be referred to when the address converter 34 actually executes the address converting operations.

Next, the address converter 34 cuts out the images 502, 504, 506 from the camera images 501, 503, 505, respectively, by referring to the address conversion table 507, to allow respective image data, forming the images corresponding to the monitor resolution with the cut out images to be synthesized, to be stored in the output buffer 16 by referring to the address conversion table 507, thereby generating the composite image 500.

[Image Calibrating Operations]

Next, a basic sequence of operations to individually correct the image areas to be provided in the images for the camera modules 2, respectively, in the image processing device 100 that restructures the address conversion tables, as set forth above, is described with reference to the flowchart of FIG. 7. Also, it is supposed that the image processing device 100 has a mode, under which a vehicle circumference image is provided to a driver, and a mode (hereinafter referred to as a calibration mode) under which the image layouts to be provided to the driver are calibrated.

As shown in FIG. 7, first in step S1, if the CPU 13 discriminates that the calibration mode is present, then, the operation goes to step S2.

In next step S2, the CPU 13 discriminates the camera module 2 for an object to be calibrated. When this takes place, upon discriminating a signal delivered from an operation system (not shown), the CPU 13 discriminates an image of the correcting object needed by a driver for discriminating the camera module 2 by which such an image is picked up.

In subsequent step S3, the CPU 13 retrieves address conversion tables, associated with image layouts to be provided to the driver, for the camera modules 2, respectively, for temporary storage in a memory (not shown). In this moment, the CPU 13 retrieves the address conversion table with an address space greater than that corresponding to the monitor resolution for the address conversion tables of the camera modules 2 discriminated to be an object for calibration in step S2. Such an address conversion table has a given leading pointer that is set as a default value.

In succeeding step S4, the table area determination section 32 acquires leading pointers of address conversion tables set for the respective camera modules. Even in cases where a plurality of image layouts are set for the images picked up by a single piece of the camera module 2, permitting the leading pointers to be sustained for the camera modules 2 resulting in no need for calibrating the respective camera image pickup areas for the respective image layouts.

In consecutive step S5, the table restructuring section 33 acquires the address conversion tables, corresponding to the respective camera modules 2, from the leading pointers of the address conversion tables for the image layouts by referring to the leading pointers for the camera modules 2 acquired in step S4. Then, the table restructuring section 33 allows the address conversion tables for the plural camera modules 2 to be combined, thereby restructuring an address conversion table for one screen to be used in actual address conversion.

In next step S6, the address converter 34 executes the address converting operations to rewrite image data of input buffers 12 to image data of the output buffer by referring to the address conversion tables restructured in step S5 and, thereafter, outputs image data from the output buffer 16 to the monitor 3 for providing the driver with the composite image.

Then, if no calibration mode is cancelled by the driver (in step S7) and the operation related to the calibration, that is, the operation intended to displace the image area of a certain camera module 2 in a left direction (in step S8), the CPU 13 executes the operation to deviate the leading pointer of the address conversion table for the camera module 2, forming a calibrating object, in accordance with operational content (step S9).

And then, executing the operations subsequent to step S5 provides the image depending on the operation related to the calibration and the operations are repeatedly executed until the calibration mode is cancelled.

As set forth above, the image processing device of the presently filed embodiment includes the address conversion tables, depending on the image layouts to be provided to the driver, that if, the address conversion tables with a resolution greater than the monitor resolution in the height direction or the width direction or in both directions and, among the address conversion tables for the respective camera modules 2, the areas for the monitor display area, allocated depending on the image layout, are determined to restructure the address conversion table for one screen to be used in address conversion using such determined areas.

This results in no need for preparing the address conversion tables depending on the degree of deviations even under a situation where the operation is executed to calibrate the deviations of the respective images involved in the image layouts, thereby enabling the realization of reduction in memory capacity.

Further, it becomes possible to calibrate the physical deviations of the camera modules 2 based on the images resulting from address conversion upon referring to the address conversion tables for the restructured monitor resolution, thereby enabling deviations of the image pickup areas, resulting from the plural camera modules 2, to be individually calibrated in automatic or manual operations.

Furthermore, the presence of a capability to individually correct the monitor display areas for the respective camera modules 2 involved in the image layouts enables reduction in the memory capacity while permitting the CPU 13 to approximate the address conversion table generating operations. Also, it becomes possible to provide an image with an image pickup area in conformity to preferences of a user.

Incidentally, while the presently filed embodiment has been mainly described above with reference to an exemplary case wherein the composite image 500 is generated based on the camera images 501, 503, 505, picked up by the plural camera modules 2, it is of course needless to say that the present invention can be applied to a case wherein a plurality of images are cut out from camera images picked up by a single camera module to generate the composite image 500.

### Fifth Embodiment

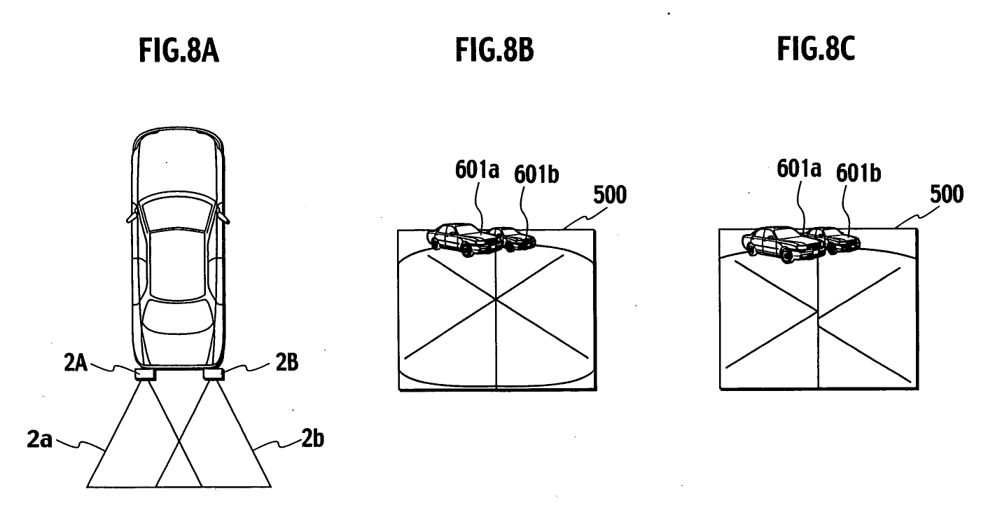

Next, an image processing device of a fifth embodiment according to the present invention is described in detail mainly with reference to the flowchart of FIGS. 8A to 10.

The image processing device of the presently filed embodiment mainly differs from the fourth embodiment in a structure wherein images are synthesized without interruption in joint between images picked up by a plurality of camera modules and the calibrations of image layouts are automatically performed. The same component parts as those of the fourth embodiment bear like reference numerals to suitably omit or simplify descriptions while description is made with a focus on differing points.

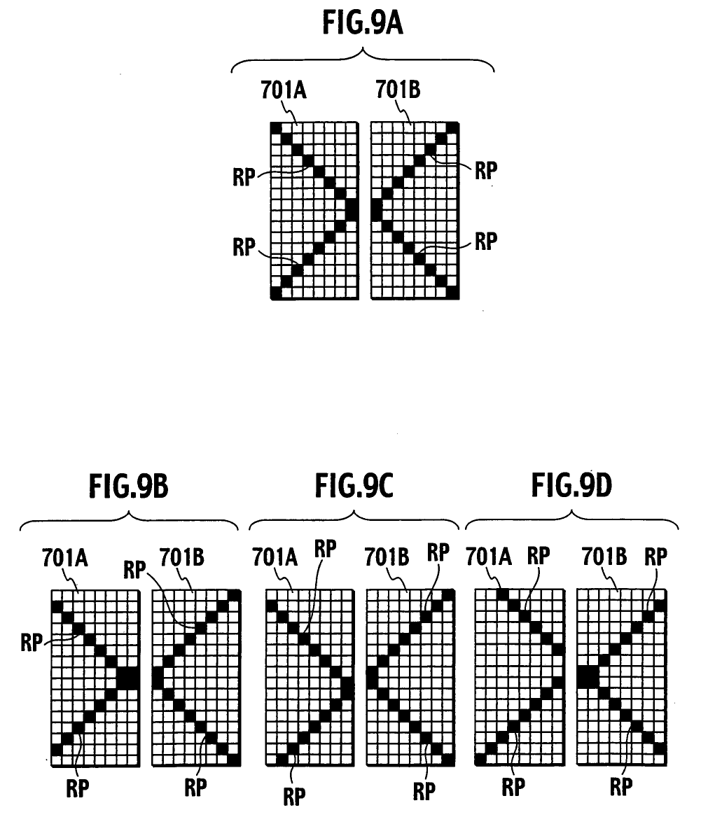

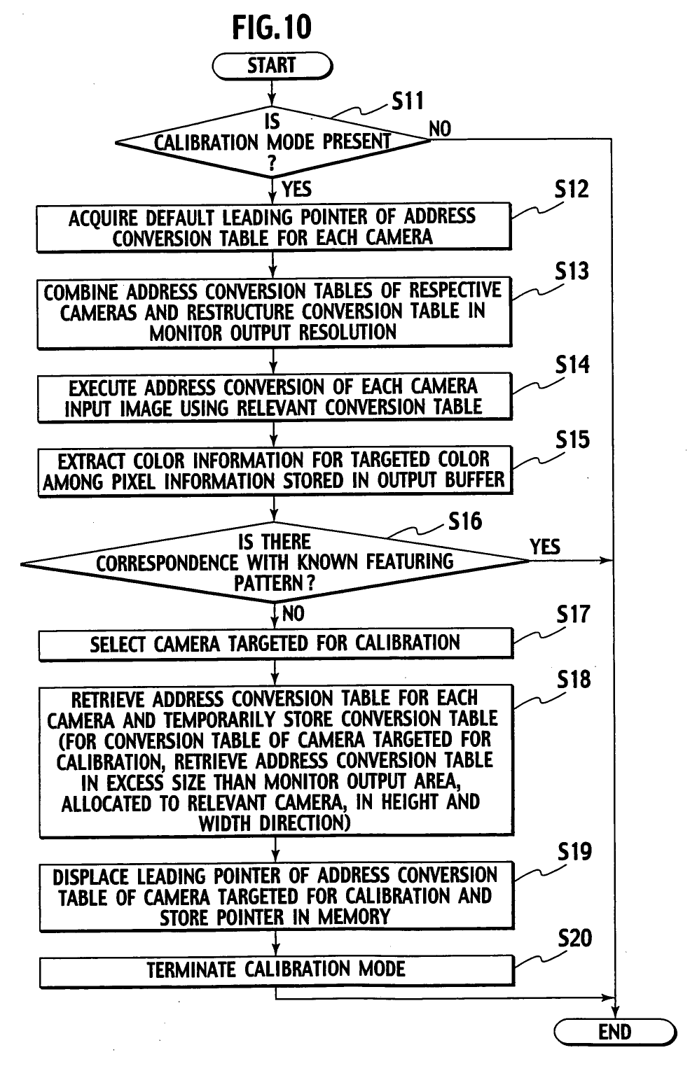

FIG. 8A is a view showing image areas of a plurality of camera modules in a vehicle circumference display system with the image processing device of the presently filed embodiment; FIG. 8B is a view showing the picked-up images with no occurrence of deviations in optical axes when picking up the images with the plural camera modules shown in FIG. 8A; FIG. 8C is a view showing the picked-up images with the occurrence of deviations in optical axes when picking up the images with the plural camera modules shown in FIG. 8A; FIG. 9A is a view showing the picked-up images with no occurrence of deviations in optical axes, when picking up the images with the plural camera modules shown in FIG. 8A, in pixels; FIGS. 9B to 9D are views showing the picked-up images with the occurrence of deviations in optical axes, when picking up the images with the plural camera modules shown in FIG. 8A, in pixels; and FIG. 10 is a flowchart showing a basic sequence of operations for calibrating the deviated optical axes of the plural camera modules in accordance with a feature of an object in the image processing device of the presently filed embodiment.

With the image processing device of the presently filed embodiment, camera modules 2A and 2B are mounted on a vehicle at rear areas thereof as shown in FIG. 8A and set to have image pickup areas for the camera modules 2A and 2B in a way to cause the image pickup area 2a of the camera module 2A and the image pickup area 2b of the camera module 2B to overlap each other.

Next, as shown in FIGS. 8B and 8C, the address conversion table for the camera module 2A is read out in respect of the image layout that allows the camera image 601a of the camera module 2A and the camera image 601b of the camera module 2B to be displayed in a juxtaposed relationship from left to right, while reading out the address conversion table for the camera module 2B. Then, the address conversion table for the camera module 2A and the address conversion table for the camera module 2B are cut out so as to cause the camera image of the camera module 2A and the camera image of the camera module 2B to be consecutive, thereby restructuring the address conversion table.

As a result, if no deviations occur in optical axes and mount positions of the camera modules 2A and 2B, the camera images 601a, 601b take the form of images consecutive via a partition line as shown in FIG. 8B. In contrast, if deviations occur in the optical axes and mount positions of the camera modules 2A and 2B, the camera images 601a, 601b take the form of images straddling the partition line to be non-consecutive as shown in FIG. 8C.

In cases where deviation occurs in image between the camera image 601a and the camera image 601b, the image processing device of the presently filed embodiment takes an intended object, whose layout in so-called characteristic feature is known, as a reference for picking up images and deviates a usage area of the address conversion table using the intended object involved in the image upon address conversion, thereby correcting the deviations in the image pickup areas of the camera modules 2.

A basic sequence of operations for calibrating the deviations in the image pickup areas of the camera modules 2 is described with reference to situations in the presence of assumption under conditions 1 to 5 as listed below for the sake of convenience for description.
1. A monitor is assumed to have the monitor resolution in 16 pixels wide by 16 pixels tall.
2. Suppose the correction is performed under circumstances shown in FIGS. 8A and 8B. The operations are executed to cut out images from images picked up by the camera modules 2A and 2B by referring to the address conversion tables, permitting the respective images to be allocated to areas from left to right each in 8 pixels wide (in a horizontal direction) by 16 pixels tall (in a vertical direction) (see FIGS. 9A to 9D).
3. Suppose pixel information is outputted from each camera in an RGB format (in 24 bits). Also, it doesn't matter if it is in the form of YCbCr format.
4. Suppose information sizes, per one pixel, for vehicle circumferences to be picked up by a plurality of cameras are equal to each other. This means that in case of the structure shown in FIG. 8A, the camera modules 2A and 2B have the same specifications and are mounted at symmetrical positions in the same orientations (of optical axes). However, even in cases where the camera modules 2A and 2B have different specifications or where the camera modules 2A and 2B are mounted in different positions with different orientations (of optical axes), it may be sufficed for the information sizes, per one pixel, within monitor screen areas allocated in result to the monitor 3 based on the respective image pickup areas to be equal to each other.
5. Patterns RP (see FIGS. 9A to 9D) obliquely intersects the known intended object, serving as a reference, and color information of such reference pattern includes color information that is absent in environments whose images are picked up. With the presently filed embodiment, suppose color information of the intended object is colored in black (0x000000) with color information around a black colored periphery being colored in white (0xFFFFFF). However, it may be sufficed for pixel information of the intended object to be discriminated in terms of color information in binary-coded black and white, contrasting density and brightness. Also, patters for asymmetric object may not be limited to intersecting patterns.

Now, with such conditions settled, as shown in FIG. 9A, if no deviations occur in the optical axes, symmetric patterns between an image 701A, picked up by the camera module 2A, and an image 701B, picked up by the camera module 2B, are detected. On the contrary, if the deviations occur in optical axes, no symmetric property is lost to be non-consecutive in pattern between the image 701A, picked up by the camera module 2A, and the image 701B, picked up by the camera 2b module 2B. Accordingly, with the image processing device of the presently filed embodiment, detecting variation in patters for such an object allows the correction of the deviation in image at the partition line as shown in FIG. 8C.

During such correcting operation, other camera module 2 than the camera modules 2A and 2B picks up an image of the intended object and a featuring pattern of such an intended object is stored. Such a featuring pattern results in a featuring pattern for a case in which the images are picked up under circumferences in the absence of deviations in the camera modules 2A and 2B and outputted to the monitor 3. Here, the intended object for obtaining the featuring pattern is assigned to take an asymmetric object located on a physical center axis between the camera modules 2A and 2B and includes one that is present in an image pickup area for the other camera module 2 than the camera modules 2A and 2B.

More particularly, as shown in FIG. 10, the CPU 13 discriminates whether or the calibration mode is present upon which if the calibration mode is present and the table area determination section 32 executes the operation in step S12 to acquire the leading pointers of the address conversion tables in default for the camera modules 2A and 2B, respectively.

In next step S13, the table restructuring section 33 acquires the address conversion tables from the leading pointers acquired in step s12, respectively, and restructures the address conversion object areas for the camera modules 2A and 2B, respectively, by taking into consideration the monitor resolution and the image layouts, thereby restructuring the address conversion tables for use in actual address conversion.

In succeeding step S14, the address converter 34 executes address conversion to rewrite image data (pixel information) of the input buffers 12 in the output buffer 16.

In consecutive step S15, the CPU 15 extracts color information (0x000000) of the intended object (featuring pattern) and a coordinates of pixels, whose color information is detected, from among pixel information stored in the output buffer 16.

In subsequent step S16, the CPU 13 makes comparison between a coordinates of pixels forming the featuring pattern detected in step S15 and a coordinates of pixels of a featuring pattern acquired before starting the operation in step S11, thereby discriminating whether or not there exists a coincidence. If discrimination is made that the coincidence exists, then, discrimination is made that no physical deviations exist in both the camera modules 2A and 2B, upon which the operation is completed, and if discrimination is made that the coincidence exists, then, the operation is executed to acquire a direction and amount of pixels in which the featuring pattern is deviated.

In next step S17, the CPU 13 allows one camera module 2 of the camera modules 2A and 2B to be targeted for calibration based on the deviated direction and the amount of deviated pixels of the featuring patterns acquired in step S16. Here, the camera module 2, which is not targeted for calibration, is treated as a relative standard for calibration.

When this takes place, the CPU 13 may select the camera module 2, whose amount of deviation in the preliminarily obtained featuring pattern is great, as the camera module 2 to be targeted for calibration. Of course, since the standard is of a relative one, the camera module 2, whose amount of deviation is great, may be targeted as the camera module 2 for standard. In this moment, image data, converted in step S14 and stored in the output buffer 16, is stored in a separate memory that is not shown.

In succeeding step 18, the CPU 13 retrieves the address conversion table, associated with the image layout to be provided to the driver, for each camera module 2 for storage in the memory that is not shown. When this takes place, the CPU 13 retrieves the address conversion table with a resolution greater than the monitor resolution, for the address conversion table for the camera module 2 discriminated to be the object for calibration in step S17. In this moment, a leading pointer of the address conversion table, related to the camera module 2 that is not targeted for calibration, is set as a default value.

In subsequent step S19, the CPU 13 acquires the amount of deviation, involved in the image picked up by the camera module that is targeted for calibration, in terms of a unit pixel such that a preliminarily stored featuring pattern and a featuring pattern, involved in the image picked up by the camera module 2 that is targeted for calibration, are consecutive. The amount of deviation represents the amount of deviation in the leading pointer of the address conversion table of the camera module 2 that is targeted for calibration and stored in the memory, which is not shown, upon which the operation is terminated (in step S20). During the rest of subsequent steps, the deviated leading pointer is used and the address conversion table is used for performing image processing.

As set forth above, with the image processing device of the presently filed embodiment, determining the leading pointer, by which a usage area of the address conversion table associated for the camera module 2 to be targeted for calibration is determined, by referring to an image subsequent to address conversion of the other camera module 2 enables the correction of the image pickup area for each camera module 2 using the relative standard. In particular, since images of a vehicle body and a bumper forming an absolute standard are not used for calibration of the image pickup area, no need arises for a correction processing mechanism to be provided for each type of vehicle.

Further, when providing a vehicle circumference in an image layout combined with images picked up by a plurality of camera modules 2, making comparison between the preliminarily obtained featuring pattern and the featuring pattern, resulting from the images picked up by the plural camera modules 2 and subjected to address conversion, allows the detection of deviations in the image pickup areas of the camera modules 2 and displacement of the usage areas of the address conversion tables based on the deviations in such image pickup areas, thereby enabling the correction of the image pickup areas of the camera modules 2 in an automatic fashion.

Furthermore, it becomes possible to calibrate the deviation in the image pickup area for each camera module 2 based on a relative position between the featuring pattern, resulting from the image pickup of the camera module 2 that is targeted for calibration, and the featuring pattern resulting from the image picked up by the separate camera. Since image information such as the vehicle body and the bumper, forming the absolute standard, is not used for calibrating the deviation in the image pickup area, no need arises for a correcting processing function to be provided for each type of vehicle.

Incidentally, while the presently filed embodiment has been described with reference to a case wherein the operation is executed to calibrate the partition line between the images picked up by the camera modules 2A and 2B, the present invention is not limited to such a case and may be applied to a case for calibrating more than two camera images.

### Sixth Embodiment

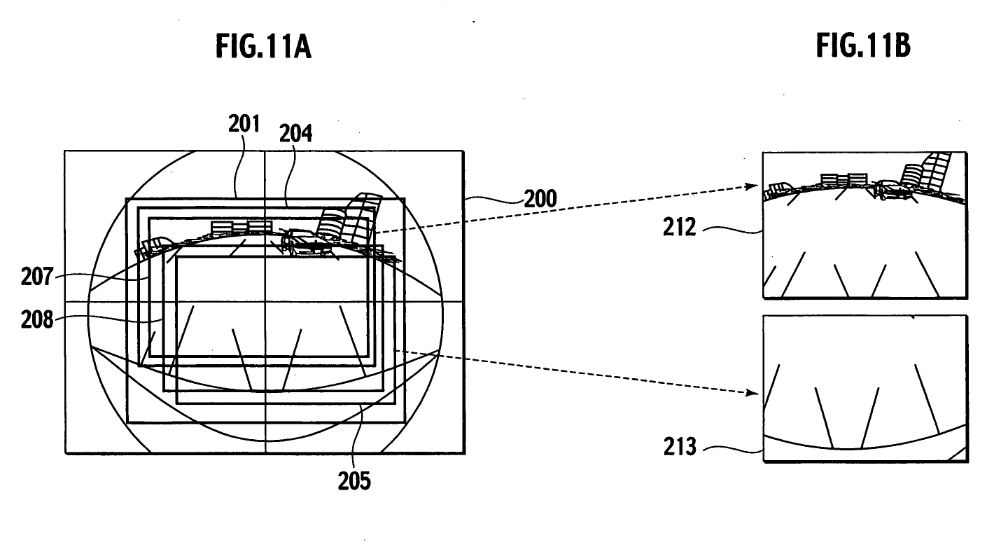

Now, an image processing device of a sixth embodiment of the present invention is described in detail mainly with reference to, in addition to FIG. 1, FIGS. 11A to 14.

The image processing device of the presently filed embodiment mainly differs from the first embodiment in respect of a structure wherein a pre-switchover image and a post-switchover image are cut out for the purpose of displaying an intermediate image while employing the structure of the first embodiment. The same component parts as those of the first embodiment bear like reference numerals to suitably omit or simplify description with description being made with a focus on differing points.

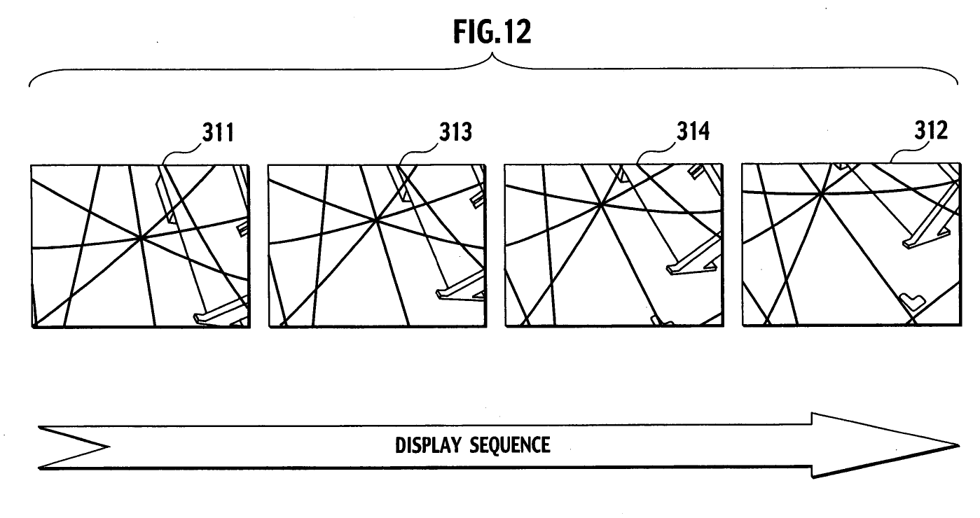

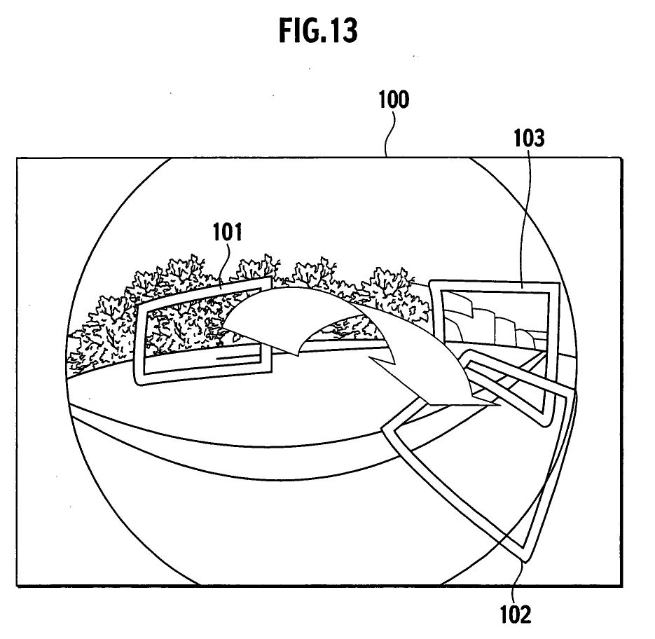

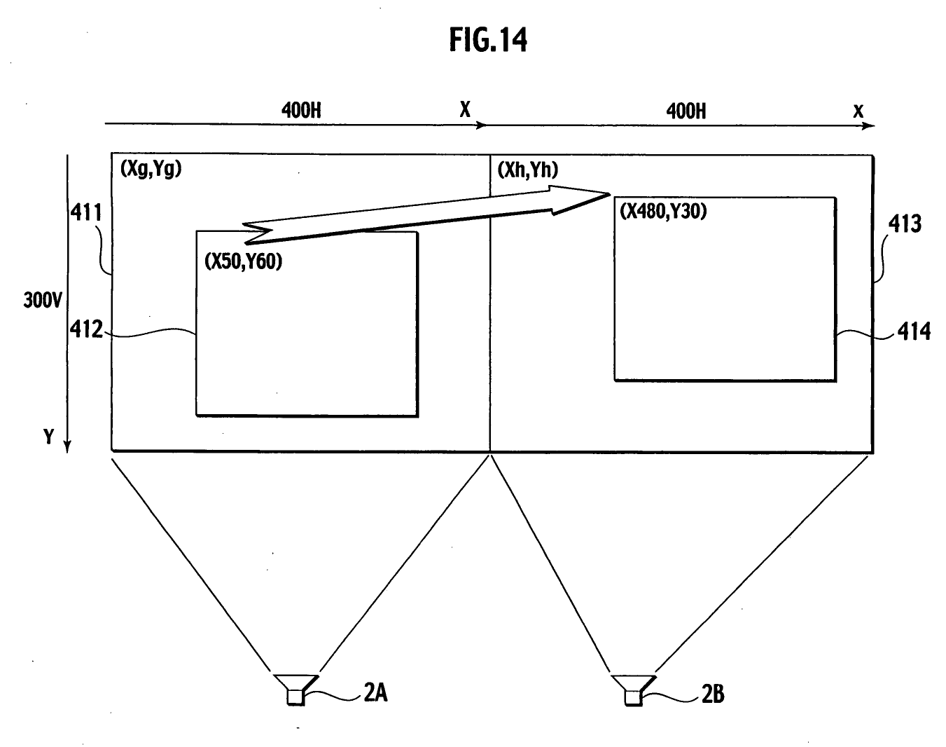

FIG. 11A is a view showing an address conversion object image in a vehicle circumference display system with an image processing device of the presently filed embodiment; FIG. 11B is a view for illustrating the operation of cutting out the pre-switchover image and the post-switchover image from the address conversion object image shown in FIG. 1A for the purpose of displaying the intermediate image; FIG. 12 is a view showing a status wherein the intermediate image is consecutively displayed between the pre-switchover image and the post-switchover image in the image processing device of the presently filed embodiment; FIG. 13 is a view showing an comparative example of the image processing device of the presently filed embodiment; and FIG. 14 is a view showing the image conversion to be executed using the address conversion table of unified address information among input image data that are picked up, in the image processing device of the presently filed embodiment.

With the image processing device of the presently filed embodiment, the structure shown in FIG. 1 serves to control an image conversion timing for the input buffers 12 of the image converter 14 and a data output timing for the output buffer 16 to output data to the monitor 3 for permitting address converting operations to be consecutively achieved to switch over the images to be consecutively displayed on the monitor 3.

[Address Converting Operations]

First, description is made of address converting operations to be executed by the image processing device with such a structure.

Even with the presently filed embodiment, if the monitor 3 takes a display mode (with the resolution of the monitor 3) in QVGA (in 320 pixels wide by 240 pixels tall) and the number of pixels in a width direction and the number of pixels in a height direction of the CCD 22, that is, the number of pixels in the width direction and the number of pixels in the height direction of image data stored in the input buffers 12 are expressed as a display mode of the monitor 3, it is supposed that the display mode of the monitor 3 takes the VGA (in 640 pixels wide by 480 pixels tall) and necessary images are cut out for address converting operations based on input image data of such VGA.

Therefore, the address conversion tables need to take the image area, with a greater lengthwise and crosswise size of the display mode of the monitor 3 in the height direction or the width direction or in both directions.

More particularly, an address space, associated with image data targeted for address converting operation, is set in 400 pixels wide by 300 pixels tall. By so doing, as shown in FIG. 11A, among the camera images (input image data) 200 (in 640 pixels wide by 480 pixels tall) picked up on the image pickup areas of the cameras, an image (address conversion image data) in 400 pixels wide by 300 pixels tall becomes an address conversion object.

Then, the camera module 2 picks up the camera image 200 (in 640 pixels wide by 480 pixels tall) with a size corresponding to the camera image pickup area for storage in the input buffers 12, thereby switching over the image, to be displayed on the monitor 3, from the display image (pre-switchover image) 212, shown in FIG. 11B, to a display image (post-switchover image) 213.

When this takes place, first, among the address spaces for 400 pixels wide by 300 pixels tall, address spaces forming the pre-switchover image 212 and the post-switchover image 213, in the monitor resolution (in 320 pixels wide by 240 pixels tall) are respectively determined by the image converter 14. Subsequently, the images forming the address spaces associated with the pre-switchover image 212 and the post-switchover image 213, among the address conversion tables in the memory addresses of the input buffers 12, are cut out, thereby cutting out the image areas 204, 205. That is, the image converter 14 reads out the image area 204 forming the pre-switchover image 212 in the camera image 200, while reading out the image area 205 forming the post-switchover image 213 in the camera image 200.

Subsequently, in cases where when switching over the pre-switchover image 212 to the post-switchover image 213, an intermediate image is displayed to allow these images to be consecutively switched, the image converter 14 cuts out the image areas 207, 208 from the image 201 during a phase from the image area 204 to the image area 205, thereby causing the pre-switchover image 212, the intermediate image cut out from the image area 207, the intermediate image cut out from the image area 208, and the post-switchover image 213 to be updated in this order and outputted to the monitor 3. When this takes place, the address converting operation is executed for converting addresses of image data to be delivered from the input buffers 12 to the output buffer 16 by sequentially referring to the address space corresponding to the image area 207 and the address space corresponding to the image area 208.

Further, when determining the address space corresponding to the image area 207 and the address space corresponding to the image area 208 based on the address conversion tables, the image converter 14 designates the leading pointers of the address spaces in the monitor resolution for use in the address converting operation. In this moment, the operation is executed to determine the leading pointer for the address space corresponding to the image area 207 and the leading pointer for the address space corresponding to the image area 208.

With the image processing device with such a structure set forth above, the operation is executed to sequentially cut out image data in the monitor resolution so as to include address information in phase from the pre-switchover image to the post-switchover image by referring to the address conversion tables when permitting the pre-switchover image, currently displayed on the monitor 3, to the post-switchover image to be subsequently displayed, thereby causing cut out image data to be generated as intermediate image data converted to address information of display image data for thereby causing the monitor 3 to consecutively display the intermediate images before the post-switchover image is displayed. Thus, even if the camera modules 2 are used with the mount positions and image pickup directions being fixed, the images to be displayed can be consecutively switched over in a simplified fashion without causing an enormous increase in a memory capacity for the address conversion tables.

More particularly, when performing image switchover from the pre-switchover image 311, currently provided to the driver, to the post-switchover image 312, as shown in FIG. 12, intermediate images 313, 314 between the pre-switchover image 311 and the post-switchover image 312 can be provided. When this takes place, no need arises for preparing the address conversion tables, in which the positions and the orientations (of the optical axes) of the camera modules 2 for the purpose of providing intermediate images 313, 314 between the pre-switchover image 311 and the post-switchover image 312, enabling a memory capacity of the table storage unit 15 to be minimized.

Further, with such a structure, since the operation is executed to cut out the address spaces to be displayed on the monitor 3 based on the address conversion table with a large address space, no need arises generating the address conversion tables for displaying the intermediate images 313, 314 on a real time basis, resulting in reduction in operating loads.

Incidentally, since use is made of only the address conversion table for a case in which the image pickup direction is fixed, a probability may occur wherein distortion takes place in the image displayed on the monitor 3 under a situation where an image in the vicinity of an edge of the camera image pickup area is targeted for address conversion. However, by restricting the image area, among the camera image pickup areas, to be targeted for address conversion and setting such that the address space of the address conversion table is greater than the resolution of the monitor 3, it becomes possible to eliminate the distortion in image in a simplified and reliable manner.

Further, in comparison to the structure of the image processing device of the presently filed embodiment, when cutting out image areas in a camera image pickup range 100 in a comparative example, shown in FIG. 13, to provide a pre-switchover image 101, a post-switchover image 102 and a post-switchover image 103, it is supposed that the pre-switchover image 101, the post-switchover image 102 and the post-switchover image 103 include address conversion tables for address spaces corresponding to the respective monitor resolutions. Such a structure results in a need for the address conversion tables to be switched over and images to be displayed on the monitor 3 are intermittently switched over. This results in a tendency with a difficulty for the driver to understand which of locations in a vehicle circumference is displayed by the post-switchover image 102 or a difficulty for the driver to understand that an image shift between the pre-switchover image 101 and the post-switchover image 102 and a positional relationship of an actual vehicle circumference are brought into coincident.

[Image Switchover Operations]

Next, description is made of a basic sequence of operations to consecutively provide a display for time between the image (pre-switchover image) currently on display and the image (post-switchover) to be subsequently displayed when switching over the images displayed on the monitor 3 among a plurality of camera modules 2A, 2B in the presently filed embodiment.

When switching over the images among a plurality of camera modules 2A, 2B in such a way, as shown in FIG. 14, an XY coordinates (Xg, Yg) of an address conversion table for performing address conversion of an address conversion object image 411 (in 400 pixels wide by 300 pixels tall), involved in an image picked up by the camera module 2A, and an XY coordinates (Xh, Yh) of an address conversion table for performing address conversion of an address conversion object image 413 (in 400 pixels wide by 300 pixels tall), involved in an image picked up by the camera module 2B, use coordinates values present in address spaces in the same size. That is, address information in the monitor resolution for a plurality of input image data is described in the address conversion tables stored in the table storage unit 15. Further, the image processing device of the presently filed embodiment is configured to prepare an address conversion table with a common address space, covering the number of pieces (here, in two pieces) of the camera modules 2, contrary to the address conversion tables for consecutively switching over the display images of the respective camera modules 2, for storage in the table storage unit 15. That is, as shown in FIG. 14, the image processing device of the presently filed embodiment includes a global address conversion table, covering the plural camera modules 2, contrary to the address conversion table for a single camera module 2 described above. This becomes synonymous with a fact to separately include a address conversion table with 800 pixels wide by 300 pixels tall, in case where the two camera modules 2 picks up images in a width direction, and when switching over the images resulting from the plural camera modules, a start position between a leading pointer of the pre-switchover image 4112 and a leading pointer of the post-switchover image 414 is displaced by referring to such address conversion table for thereby acquiring an intermediate image.

Incidentally, even under a situation where there are more than three camera modules 2, it may be sufficed for preparing address conversion tables to allow images, picked up by the more than three camera modules 2, to be consecutively displayed.

The image processing device with such a structure mentioned above is configured to separately include a unified address conversion table, covering the plural camera modules 2, contrary to a general address conversion table, whereby when performing switchover of the images, it becomes possible to consecutively display an intermediate image between a pre-switchover image and an post-switchover image resulting from different camera modules 2. On the contrary, in cases where different address conversion tables are prepared for the camera modules 2A, 2B, a difficulty is encountered in consecutively displaying the image from between the pre-switchover image 412 and the post-switchover image 414, that is, it becomes hard to consecutively perform a shift from the leading pointer of the pre-switchover image 412 and the leading pointer of the post-switchover image 414.

Further, even in cases where the pre-switchover image 412 and the post-switchover image 414 are different in image size, progressively increasing the address space of the intermediate image between the leading pointer of the pre-switchover image 412 and the leading pointer of the post-switchover image 414 enables the switchover to be consecutively executed without causing a feeling of strangeness.

Furthermore, even in cases where no duplication occurs in image pickup ranges for the plural camera modules 2, preparing an address conversion table with a common address enables the realization of switchover on consecutive images.

[Image Updating Speed Control Operation]

Next, detailed description is made of a basic sequence of operations for controlling an image updating speed (switchover speed) when making switchover from the pre-switchover image to the post-switchover image.

With such an operation to control the image updating speed, during a process of consecutively updating (switching over) between the pre-switchover image and the post-switchover image, a shift speed of the intermediate image close proximity to the pre-switchover image and the post-switchover image is set to a low speed and a shift speed of the other intermediate image is set to a high speed for display. This is due to the fact that no need arises for a shift speed of the intermediate image between the pre-switchover image and the post-switchover image to be fixed and it may be sufficed for a driver to recognize an actual vehicle circumference position of the post-switchover image upon the occurrence of a shift from an actual vehicle circumference position of the pre-switchover image in any direction while it may be sufficed for a positional relationship of a vehicle circumference to be recognized in the pre-switchover image and the post-switchover image.

Here, the CPU 13 or the image converter 14 prepare the intermediate image, close to address information of the pre-switchover image and the post-switchover image, and the intermediate image, which is not close to address information of the pre-switchover image and the post-switchover image in distinction from each other.

When altering the shift speed (switchover speed) in such a way, the image converter 14 limits the number of address conversion tables for preparing the images to be displayed between the pre-switchover image and the post-switchover image. More particularly, in areas around the pre-switchover image and the post-switchover image, an image area is cut out upon deviating the leading pointer by one dot to generate the intermediate image whereas in an image position of other area, the intermediate image is generated by cutting out the image area such that the leading pointer is deviated so as to exceed by one dot. This means that the number of the leading pointers in the areas, closer to the pre-switchover image and the post-switchover image, is increased and in other areas, the number of the leading pointers are decreased.

That is, the CPU 13 or the image converter 14 generate greater numbers of intermediate images with address information closer to address information of the pre-switchover image and intermediate images with address information closer to address information of the post-switchover image than those of intermediate images with address information, which is not closer to address information of the pre-switchover image, and intermediate images with address information that is not closer to address information of the post-switchover image.

By so doing, it becomes possible to reduce the number of times for address conversion to be executed and the amount of operations for the images to be cut out from the input buffers 12 to values lower than those of cases in which a fixed number of leading pointers are set between the pre-switchover image and the post-switchover image to perform address conversions, respectively, thereby enabling reduction in operating load of the image converter 14.

Incidentally, the other example of operations to control the image updating speed may include a step of altering a display time interval of the monitor 3 by fixing the amount of displacement of the leading pointer of the intermediate image in a phase between the pre-switchover image and the post-switchover image. If an image transmission system, in which images are delivered from the camera modules 2 to the vehicle image conversion device 1, takes an NTSC system, one frame, picked up by the camera module 2, is updated for a time interval of 33 ms whereas in areas closer to the pre-switchover image and the post-switchover image, a time interval for one sheet of intermediate image to be displayed is set to 300 ms (in 90 frames) while in other cases, a time interval for one sheet of intermediate image to be displayed is set to 100 ms (in 3 frames). When this takes place, the CPU 13 controls an address conversion timing for the image converter 14 and an output timing of the output buffer 16 based on the positional relationship between the leading pointer of the pre-switchover image and the leading pointer of the post-switchover image, and the leading pointer of the intermediate image that is currently displayed.

That is, the CPU 13 or the image converter 14 operate such that the display time intervals of the intermediate image, having address information closer to address information of the pre-switchover image, and the intermediate image, having address information closer to address information of the post-switchover image, are longer than the display time intervals of the intermediate image, having address information that is not closer to address information of the pre-switchover image, and the intermediate image, having address information that is not closer to address information of the post-switchover image.

Thus, upon varying the time interval for the intermediate image between the pre-switchover image and the post-switchover image to be displayed on the monitor 3, the driver is caused to recognize a shift direction from the pre-switchover image and the post-switchover image, while enabling the driver to recognize the positional relationship between a displayed image and an actual vehicle circumference in a further detailed fashion.

Further, as factors by which the shift speed of the intermediate image is determined, use may be made of shift speed information of a vehicle that is detected by a speed sensor that is not shown. During running of a vehicle at a low speed such as when parking, the shift speed of the intermediate image between the pre-switchover image and the post-switchover image is set to a low speed so as to allow the driver to recognize an image pickup position. On the contrary, in cases where the vehicle is running at a speed greater than a certain fixed speed, the vehicle image conversion device 1 operates in a way to set the shift speed of the intermediate image to be higher than that of the intermediate image between the pre-switchover image and the post-switchover image.

With such a structure set forth above, the CPU 13 or the image converter 14 determine the shift speed for the intermediate speed to be switched over based on the speed of the own vehicle, enabling the realization of the speed at which the display switchover is executed in conformity to a driving status of the driver.

Incidentally, it is of course possible for a so-called writing-in address converting operation to be applied to image information, delivered from the camera modules 2, for sequentially referring to the address conversion tables for storage in the output buffer 16.

### Seventh Embodiment

Now, an image processing device of a seventh embodiment according to the present invention is described in detail mainly with reference to, in addition to FIG. 1, FIGS. 1A to 14.

The image processing device of the presently filed embodiment mainly differs from the sixth embodiment in structure that discriminates whether or not the movement of an object, forming an obstacle, is recognized. Hereunder, the same component parts as those of the sixth embodiment bear like reference numerals to suitably omit or simplify description with a focus on differing points.

More particularly, the image processing device of the presently filed embodiment is configured such that the CPU 13 monitors image signals outputted from the camera modules 2 to discriminate whether or not the movement of the object, forming the obstacle, is recognized in an area outside an image area with the output resolution of the monitor 3 from which an image is cut out as an address conversion object. When this takes place, the CPU 13 acquires a so-called optical flow to allow the calculation of speed vectors on arbitrary pixels and figures in the image outside the image area with the output resolution of the monitor 3.

Then, the CPU 13 operates to alter the image area with the output resolution of the monitor 3 to be cut out as an address conversion object at a timing, at which the movement of the object in the area outside the image area with the output resolution to be targeted for address conversion is detected, to set the image area to the post-switchover image. When this takes place, the image converter 14 operates to shift the leading pointers in parallel to each other to consecutively switch over the pre-switchover image to the post-switchover image involving the moving object. Further, in this moment, the CPU 13 and the image converter 14 execute the operations set forth above, thereby consecutively displaying intermediate images before the post-switchover image involving the moving object appears.

In particular, in FIG. 1A, the image 201, which corresponds to the camera image pickup area and which the vehicle image conversion device 1 is able to provide to the driver, depends on a size of the address conversion table, that is, the address space. Accordingly, the image area, actually displayed on the monitor 3, can be generated by cutting out the image area, in the monitor resolution, cut out upon referring to the address conversion table, such as the pre-switchover image 212 and the post-switchover image 213.

In contrast, the presently filed embodiment is configured in a way to monitor the image area, whose image recognizing section (not shown), contained in a function of the CPU 13, remains in the image 201 but remains outside the pre-switchover image 212, under a situation wherein the pre-switchover image 212 is displayed. The leading pointer is shifted so as to cut out the image area for such a moving object to be displayed at a timing in which the moving object is recognized by the image recognizing section.

With the structure set forth above, the driver can be provided with a display of a sudden darting out of a child, enabling the driver to recognize a direction in which a moving object is present.

The entire content of a Patent Application No. TOKUGAN 2004-239295 with a filing date of Aug. 19, 2004 in Japan and the entire content of a Patent Application No. TOKUGAN 2004-239296 with a filing date of Aug. 19, 2004 in Japan are hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. An image processing device comprising:
an input section through which input image data is inputted from an image pickup device, the input image data being obtained through the image pickup device picking up an image of a circumference;
a storage section storing an address conversion table describing a relation between address information of the input image data and address information of display image data corresponding to a display resolution, the display resolution being defined with the number of pixels in height and width directions of a display, and an address space of the address information of the input image data having a size greater in a height direction or a width direction than that of the display image data;
an image processing section processing the input image data to cut out image data, corresponding to the display resolution, from the input image data upon referring to the address conversion table, for thereby allowing address information of the resultant cut out image data to be converted to address information of the display image data; and
an output section outputting the display image data, resulting from conversion of the address information by the image processing section, to the display.

2. The image processing device according to claim 1, wherein the image processing section is operative to set a leading pointer for the address conversion table, to be used in cutting out the image data corresponding to the display resolution, for the image pickup device, to allow the input image data to be cut out from the leading pointer of the address conversion table.

3. The image processing device according to claim 1, wherein the image pickup device generates the input image data upon picking up images covering a given circumference of an own vehicle, and the image processing section is operative to shift the image data, cut out from the input image data corresponding to the display resolution, in accordance with a behavior of the own vehicle, for thereby cutting out image data involving the given circumference.

4. The image processing device according to claim 1, wherein the image processing section cuts out overlay data, to be superimposed on the image data corresponding to the display resolution, from overlay data with an address space with a size greater in height and width directions than that of the display image data the display resolution.

5. The image processing device according to claim 1, wherein the image processing section preliminarily stores overlay data to be displayed in a given position of a display screen of the display and shifts a position for cutting out the image data corresponding to the display resolution such that the given position, in which the overlay data is displayed, and a position of an object, involved in the input image data, are brought into coincidence with each other on the display screen.

6. The image processing device according to claim 5, wherein the overlay data relates to a portion of an own vehicle.

7. The image processing device according to claim 1, wherein the image pickup device includes a plurality of image pickup units, whose image pickup ranges are different from each other, and the storage section stores a plurality of address conversion tables allocated in accordance with an image layout to be provided on the display with an image in combination with a plurality of input image data picked up through the plurality of image pickup units, the plurality of address conversion tables having address spaces each of which has a size greater in a height direction or a width direction than that of the display image data corresponding to associated one of the plurality of image pickup units;
wherein the image processing section is provided with:
a table area determination section extracting the plurality of address conversion tables in accordance with the image layout to be provided on the display; and
a table restructuring section determining areas for cutting out image data allocated in accordance with the image layout for each of the plurality of address conversion tables, respectively, which are extracted by the table area determination section, and restructuring an address conversion table having an address space corresponding to the display resolution in combination with the plurality of address conversion tables which are extracted by the table area determination section;
and wherein the image processing section cuts out the image data allocated in accordance with the image layout for each of the plurality of input image data, respectively, upon referring to the address conversion table that are restructured by the table restructuring section.

8. The image processing device according to claim 7, wherein the table restructuring section is operative to shift a leading pointer of an address conversion table, among the plurality of address conversion tables extracted from the table area determination section, which is relevant to any one of the plurality of image pickup units to be targeted for calibrating an input image data picked up therethrough, for thereby shifting an area of the address conversion table for cutting out image data allocated in accordance with the image layout.

9. The image processing device according to claim 8, wherein the storage section stores the leading pointer of each address conversion table, based on which the image data allocated in accordance with the image layout is cut out, for each of the plurality of image pickup units.

10. The image processing device according to claim 8, wherein the image processing section shifts the leading pointer of each address conversion table for each of the plurality of image pickup units, respectively, to cut out a plurality of image data allocated in accordance with the image layout for each of the plurality of image pickup units, respectively.

11. The image processing device according to claim 7, wherein the image processing section converts image data, allocated in accordance with the image layout based on input image data picked up through one of the plurality of image pickup units, and shifts a leading pointer of an address conversion table of the other one of the plurality of image pickup units by referring to the display image data, for thereby cutting out image data allocated in accordance with the image layout based on input image data picked up through the other one of the image pickup units.

12. The image processing device according to claim 7, wherein the image processing section acquires a feature of an object, involved in image pickup ranges of the plurality of image pickup units, and shifts the leading pointer of each address conversion table so as to make the feature of the object continuous, for thereby cutting out image data allocated in accordance with the image layout, from the plurality of input image data.

13. The image processing device according to claim 1, wherein the image processing section is operative such that when switching a pre-switchover image, currently displayed on the display, over to a post-switchover image to be subsequently displayed on the display, image data, corresponding to the display resolution with address information between address information of the pre-switchover image and that of the post-switchover image, is cut out from the input image data, and generates an intermediate image, in which address information of the image data is converted to address information of the display image data, for thereby consecutively converting the intermediate image to be displayed before the post-switchover image is displayed.

14. The image processing device according to claim 13, wherein the input section allows a plurality of input image data to be inputted from a plurality of image pickup units, whose image pickup ranges are different from each other, and the storage section stores a plurality of address conversion tables describing address information each with a size corresponding to the display resolution for each of the plurality of input image data.

15. The image processing device according to claim 13, wherein the image processing section is operative to allow a switchover speed for the intermediate image, to be displayed before the pre-switchover image is switched over to the post-switchover image, to be set such that both the intermediate image, having address information closer to address information of the pre-switchover image, and the intermediate image, having address information closer to address information of the post-switchover image, move at a further low speed.

16. The image processing device according to claim 13, wherein the image processing section is operative to generate further increased numbers of both the intermediate image, having address information closer to address information of the pre-switchover image, and the intermediate image having address information closer to address information of the post-switchover image.

17. The image processing device according to claim 13, wherein the image processing section is operative to allow both the intermediate image, having address information closer to address information of the pre-switchover image, and the intermediate image, having address information closer to address information of the post-switchover image, to be set in further increased display time intervals.

18. The image processing device according to claim 13, wherein the image processing section determines a switchover speed for the intermediate image, to be switched over, based on a speed of an own vehicle.

19. The image processing device according to claim 13, wherein the image processing section is operative such that if a moving object is detected in image data outside image data cut out from the input image data, image data corresponding to the display resolution is cut out in a way to involve the moving object, for thereby setting the resultant cut out image data to be the post-switchover image.

20. An image processing device comprising:
inputting means for inputting image data from an image pickup device picking up an image of a circumference;
storing means for storing an address conversion table describing a relation between address information of the input image data and address information of display image data corresponding to a display resolution, the display resolution being defined with the number of pixels in height and width directions of a display, and an address space of the address information of the input image data having a size greater in a height direction or a width direction than that of the display image data;
image processing means for processing the input image data to cut out image data, corresponding to the display resolution, from the input image data upon referring to the address conversion table, for thereby allowing address information of the resultant cut out image data to be converted to address information of the display image data; and
output means for outputting the display image data, resulting from conversion of the address information, to the display.
